(19) United States
(12) Patent Application Publication
(10) Pub. No.: US 2016/0035312 A1
(43) Pub. Date: Feb. 4, 2016

(54) DISPLAY APPARATUS AND METHOD OF CONTROLLING THE DISPLAY APPARATUS

(71) Applicant: SAMSUNG ELECTRONICS CO., LTD., Suwon-si (KR)

(72) Inventors: Nam-suk LEE, Suwon-si (KR); Jung-hye MIN, Yongin-si (KR); Myung-jin EOM, Seoul (KR); Moon-joo LEE, Suwon-si (KR)

(73) Assignee: SAMSUNG ELECTRONICS CO., LTD., Suwon-si (KR)

(21) Appl. No.: 14/814,748

(22) Filed: Jul. 31, 2015

(30) Foreign Application Priority Data
Jul. 31, 2014 (KR) 10-2014-0098647

(51) Int. Cl. G09G 5/00; G06F 9/445; G06F 3/14

(52) U.S. Cl. CPC G09G 5/003; G06F 3/1423; G06F 8/61; G09G 2370/16

(57) ABSTRACT

A first display apparatus includes a detector configured to detect a second display apparatus in proximity with the first display apparatus; a transparent display configured to display an image and receive a user input in an overlapping area of the transparent display, wherein the overlapping area is in proximity with the second display apparatus; a communicator configured to form a communication link with the second display apparatus when the second display apparatus is detected, and transmit, to the second display apparatus, a request related to an object corresponding to the user input via the communication link when the user input is received; and a controller configured to obtain data corresponding to the request via the communicator.

### CROSS-REFERENCE TO RELATED APPLICATION

This application claims priority from Korean Patent Application No. 10-2014-0098647, filed on Jul. 31, 2014, in the Korean Intellectual Property Office, the disclosure of which is incorporated herein in its entirety by reference.

### BACKGROUND

1. Field

The present disclosure relates to a display apparatus and a method of controlling the display apparatus, and more particularly, to a method of controlling a display apparatus, including a transparent display, in such a manner that the display apparatus transmits data to another display apparatus, and the display apparatus.

2. Description of the Related Art

Electronic terminals provide a user with various functions such as a communication function and a content output function. As electronic terminals provide such various functions, they have become widely used in many industries and in daily life. Also, as a large number of electronic terminals are distributed, there is an increasing need to share data between the electronic terminals.

In addition, with the development of display technologies, a flexible display, a transparent display, and the like have been developed, and an electronic terminal including a transparent display has been developed based on the transparent display. Since the transparent display has transparent front, rear, and side surfaces, light may pass therethrough. Thus, a user of the electronic terminal may detect light generated by a light source positioned at an opposite side of the electronic terminal to the user. Accordingly, there is a need to develop a method of sharing data between the electronic terminal and another terminal by using an apparatus including a transparent display.

### SUMMARY

According to an aspect of an exemplary embodiment, a first display apparatus may be provided. The first display apparatus may include a detector configured to detect a second display apparatus in proximity with the first display apparatus; a transparent display configured to display an image and receive a user input in an overlapping area of the transparent display, wherein the overlapping area may be in proximity with the second display apparatus; a communicator configured to form a communication link with the second display apparatus when the second display apparatus is detected, and transmit, to the second display apparatus, a request related to an object corresponding to the user input via the communication link when the user input is received; and a controller configured to obtain data corresponding to the request via the communicator.

The object may be displayed on the second display apparatus in an overlapped area of the second display apparatus, wherein the overlapped area corresponds to the overlapping area.

The communicator may be configured to transmit information about a location of the user input to the second display apparatus together with the request.

The controller may be further configured to map location information of the transparent display to location information of the second display apparatus.

The controller may be further configured to determine, based on the mapped location information, whether an object at the location of the user input is displayed on the transparent display or is displayed on the second display apparatus, and the communicator may be configured to transmit the request when the object is determined to be displayed on the second display apparatus.

When the object may be an application, the controller may be configured to obtain an application installation file for the application via the communicator, and to install the application using the application installation file.

The detector may be configured to detect contact between the second display apparatus and the transparent display, and the communicator may be configured to form the communication link when the contact is detected.

The controller may be further configured to map location information on the second display apparatus to location information on the transparent display based on at least one contact location where the second display apparatus contacts the transparent display.

According to another aspect of an exemplary embodiment, a second display apparatus may be provided. The second display apparatus may include a display configured to display at least one object; a detector configured to detect a first display apparatus, the first display apparatus including a transparent display; a communicator configured to form a communication link with the first display apparatus when the first display apparatus is detected, and to receive a request from the first display apparatus via the communication link; and a controller configured to, in response to the request, select an object corresponding to the request from the at least one object, and provide the first display apparatus with data corresponding to the selected object via the communicator.

The selected object may be displayed on an overlapped area of the second display apparatus, and the overlapped area is in proximity with the transparent display.

The controller may be configured to map location information of the second display apparatus in the overlapped area to location information of the transparent display, and to select the object based on the mapped location information.

The detector may be configured to detect contact between the second display apparatus and the transparent display, and the controller may be configured to map the location information in the overlapped area to the location information on the transparent display based on at least one contact location where the transparent display contacts the second display apparatus.

According to another aspect of an exemplary embodiment, there is provided a method of controlling a first display apparatus, the first display apparatus including a transparent display, may include forming a communication link with a second display apparatus when the second display apparatus is detected in proximity with the first display apparatus; transmitting, to the second display apparatus, a request related to an object corresponding to a user input regarding an overlapping area of the transparent display via the communication link when the user input is received; and obtaining data corresponding to the request, wherein the overlapping area is in proximity with the second display apparatus.

The object may be displayed on an overlapped area of the second display apparatus, and the overlapped area may correspond to the overlapping area of the first display apparatus.

The transmitting of the request may include transmitting information regarding a location of the user input to the second display apparatus.

The method may include mapping location information on the transparent display to location information on the second display apparatus.

The method may include determining, based on the mapped location information, whether an object at the location of the user input is displayed on the transparent display or is displayed on the second display apparatus, and the transmitting of the request may include transmitting the request when the object is displayed on the second display apparatus.

Obtaining the data may include obtaining an application installation file associated with the object, and the method may include installing an application using the obtained application installation file.

Forming the communication link may include detecting contact between the second display apparatus and the transparent display.

The method may include mapping location information on the second display apparatus to location information on the transparent display based on at least one contact location where the second display apparatus contacts the transparent display.

According to yet another aspect of an exemplary embodiment, a method of controlling a second display apparatus may include detecting a first display apparatus; forming a communication link with the first display apparatus; receiving a request from the first display apparatus via the communication link; selecting an object corresponding to the request from among at least one object displayed on the second display apparatus; and providing data corresponding to the selected object to the first display apparatus.

The selected object may be displayed on an overlapped area of the second display apparatus, and the overlapped area may be in proximity with the first display apparatus.

The method may include mapping location information in the overlapping area to location information on the first display apparatus, selecting the object may include selecting the object based on the mapped location information.

Detecting the first display apparatus may include recognizing contact between the second display apparatus and the first display apparatus, and mapping the location information may include mapping the location information in the overlapped area to location information on the transparent display based on at least one contact location where the transparent display contacts the second display apparatus.

A non-transitory computer-readable recording medium may recorded thereon a computer program for performing the methods above.

According to a still further aspect of an exemplary embodiment, a first display apparatus, may include a communicator configured to communicate with a second display apparatus; a transparent display configured to receive a user input, wherein an overlapped area of the second display apparatus is visible through an overlapping area of the transparent display; a controller configured to, in response to receiving the user input corresponding to an object, control the communicator to transmit a request relating to the object to the second display apparatus, and to obtain data relating to the object from the second display apparatus.

The object may be displayed on the overlapped area, and may be visible through the overlapping area.

The object may be an application execution icon, and the data relating to the object may be an installation file for installing the application on the first display apparatus.

The object may be an image, and the data relating to the object may be an address for obtaining the image.

The object may be contact information, and the data relating to the object may be at least one of the contact information or a command for using the contact information.

The object may be a security authentication image, and the request includes an input security authentication pattern corresponding to the security authentication image.

The object may be displayed on the overlapping area.

The object may be an application execution icon, and the request includes an installation file for installing the application on the second display apparatus.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a block diagram of a structure of a first display apparatus according to some exemplary embodiments;

FIG. 2 illustrates a schematic block diagram of a structure of a first display apparatus according to some exemplary embodiments;

FIG. 3 illustrates a block diagram of a structure of a second display apparatus according to some exemplary embodiments;

FIG. 4 illustrates a schematic block diagram of a structure of a second display apparatus according to some exemplary embodiments;

FIG. 5 illustrates a schematic conceptual view of a structure in which content is shared between display apparatuses, according to some exemplary embodiments;

FIG. 6 illustrates a conceptual view of a detailed structure of a transparent display according to some exemplary embodiments;

FIG. 7 illustrates a conceptual view of a detailed structure of a transparent display including multiple transparent display layers, according to some exemplary embodiments;

FIG. 8 illustrates a schematic conceptual view of a structure of a transparent display of a first display apparatus, according to some exemplary embodiments;

FIG. 9 illustrates a schematic conceptual view of a structure of a display of a second display apparatus, according to some exemplary embodiments;

FIG. 10 illustrates a flowchart of a process of controlling a first display apparatus, according to some exemplary embodiments;

FIGS. 11A-11B illustrate a conceptual view of an example in which a first display apparatus is in proximity with, or close or adjacent to a second display apparatus on which an object is displayed from a point of view of a user;

FIG. 12 illustrates a conceptual view for explaining whether components of a first display apparatus and a second display apparatus are activated when the first and second display apparatuses are adjacent to each other, according to some exemplary embodiments;

FIG. 13 illustrates a block diagram for explaining a communication method of a first display apparatus and a second display apparatus, according to some exemplary embodiments;

FIG. 14 illustrates a block diagram for explaining a communication method of a first display apparatus and a second display apparatus, according to other exemplary embodiments;

FIG. 15 illustrates a block diagram for explaining a method of obtaining data by a first display apparatus or a second display apparatus, according to some exemplary embodiments;

FIG. 16 illustrates a flowchart of a process of providing an object to a first display apparatus from a second display apparatus, according to some exemplary embodiments;

FIG. 17 illustrates a flowchart of a process of controlling a first display apparatus receiving an object from a second display apparatus, according to other exemplary embodiments;

FIGS. 18A-18C illustrate conceptual views of a method of mapping location information of a first display apparatus to location information of a second display apparatus, according to some exemplary embodiments;

FIGS. 19 to 23 illustrate conceptual views of an example in which objects related to applications displayed on a second display apparatus are obtained, according to some exemplary embodiments;

FIG. 24 illustrates a conceptual view of a method of selecting an object displayed on a second display apparatus, according to some exemplary embodiments;

FIG. 25 illustrates a flowchart of processes of selecting an object displayed on a second display apparatus and obtaining data regarding the selected object, according to some exemplary embodiments;

FIGS. 26 and 27 illustrate a method of selecting an object displayed on a second display apparatus, according to the exemplary embodiments of FIG. 25;

FIGS. 28 to 30 illustrate an example in which a first display apparatus obtains data when an object displayed on a second display apparatus is a static image, according to some exemplary embodiments;

FIGS. 31 to 34 illustrate a method of controlling a first display apparatus according to other exemplary embodiments;

FIG. 35 illustrates a flowchart of a process of obtaining, by a first display apparatus, data, according to some exemplary embodiments;

FIGS. 36 and 37 illustrate a method of obtaining, by a first display apparatus, data, based on the exemplary embodiments of FIG. 35;

FIG. 38 illustrates a flowchart of a process of obtaining, by a first display apparatus, data or a process of providing data to a second display apparatus, according to some exemplary embodiments;

FIGS. 39 and 40 illustrate a method of obtaining, by a first display apparatus, data, or a method of providing data to a second display apparatus, based on the process of FIG. 38;

FIGS. 41 to 43 illustrate a method of obtaining, by a first display apparatus, information about objects displayed on a second display apparatus, according to some exemplary embodiments;

FIG. 44 illustrates an example in which a first display apparatus obtains data when an object displayed on a second display apparatus is multimedia content; and

FIGS. 45 to 47 illustrate a method of performing security authentication according to some exemplary embodiments.

### DETAILED DESCRIPTION

The present disclosure will now be described more fully with reference to the accompanying drawings, in which exemplary embodiments of the present disclosure are shown. The present disclosure may, however, be embodied in many different forms and should not be construed as being limited to the exemplary embodiments set forth herein; rather, these exemplary embodiments are provided so that this disclosure will be thorough and complete, and will fully convey the exemplary embodiments to those of ordinary skill in the art. In the drawings, portions that are not related to the detailed explanations of the present disclosure are omitted to clearly describe the present disclosure, and like reference numerals in the drawings denote like elements.

Throughout the specification, it will be understood that when a portion is referred to as being “connected to” another portion, it can be “directly connected to” the other portion, but the portion may be “electrically connected to” the other portion having an intervening component therebetween. Also, when a portion “includes” an element, another element may be further included, rather than excluding the existence of the other element, unless otherwise described.

In the specification, the term “touch” or “touch input” may include a direct touch of a user or a case where a display apparatus detects that a body part of the user is adjacent to the display apparatus (e.g., within 2 cm), i.e., a proximity touch. Also, “dragging” may be a user's motion of touching the display apparatus with the finger or touch tool and then moving the finger or touch tool to another position on the display apparatus.

Hereinafter, the present disclosure will be described in detail by explaining exemplary embodiments of the present disclosure with reference to the attached drawings.

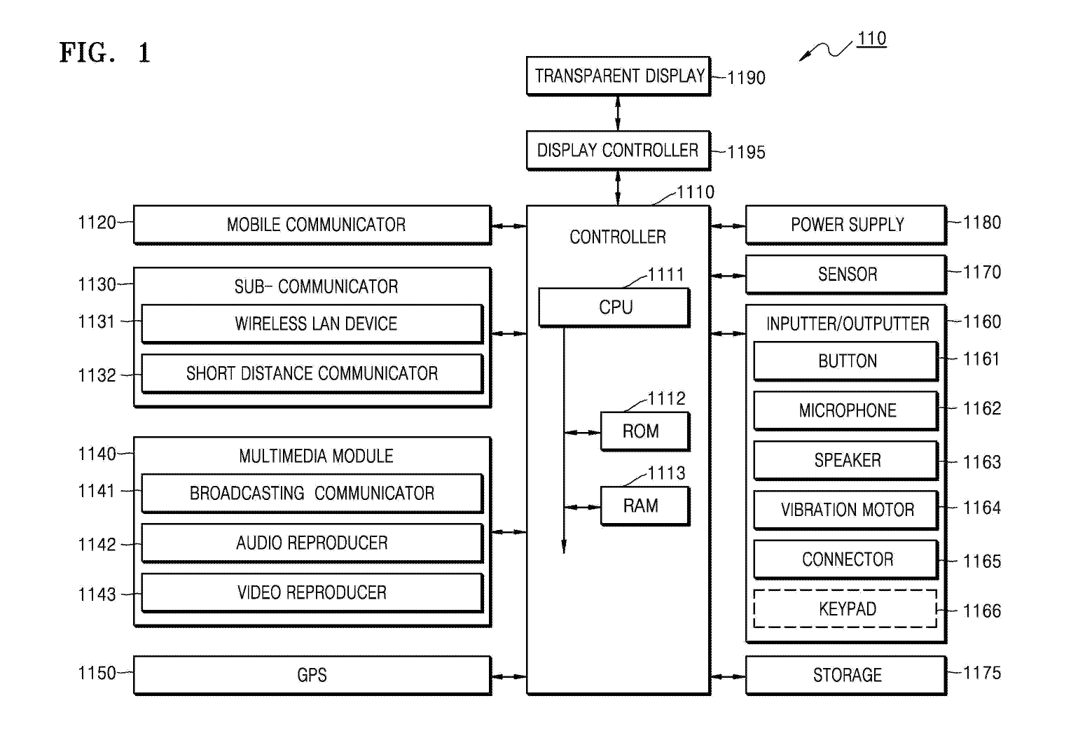

FIG. 1 illustrates a block diagram of a structure of a first display apparatus 110 according to an exemplary embodiment. FIG. 1 illustrates the first display apparatus 110 according to an exemplary embodiment, and a first display apparatus according to one or more exemplary embodiments may include more or less components than the first display apparatus 110 of FIG. 1. The first display apparatus 110 may include a device including a display, for example, a mobile phone, a smart phone, a tablet personal computer (PC), a laptop, an e-book terminal, a digital broadcasting terminal, a personal digital assistant (PDA), a portable multimedia player (PMP), a navigation device, a TV, or a PC.

The first display apparatus 110 may be connected to an external device by using a mobile communicator 1120, a sub-communicator 1130, and a connector 1165. Here, the external device may be a second display apparatus 100 of FIG. 5. Alternatively, the external device may include at least one of another device, a mobile phone, a smart phone, a tablet PC, and a server.

Referring to FIG. 1, the first display apparatus 110 may include a transparent display 1190 and a display controller 1195. Also, the first display apparatus 110 may include a controller 1110, the mobile communicator 1120, the sub-communicator 1130, a multimedia module 1140, a Global Positioning System (GPS) module 1150, an inputter/outputter 1160, sensors 1170, a storage 1175, and a power supply 1180. The sub-communicator 1130 may include at least one of a wireless local area network (LAN) device 1131 and a short distance communicator 1132. The multimedia module 1140 may include at least one of a broadcasting communicator 1141, an audio reproducer 1142, and a video reproducer 1143. The inputter/outputter 1160 may include at least one of a button 1161, a microphone 1162, a speaker 1163, a vibration motor 1164, the connector 1165, and a keypad 1166.

The controller 1110 may include a central processing unit (CPU) 1111, read-only memory (ROM) 1112 that stores a control program for controlling the first display apparatus 110, and random access memory (RAM) 1113 that stores a signal or data that is input from the outside of the first display apparatus 110 or is used as a memory space for performing operations in the first display apparatus 110. The CPU 1111, the ROM 1112, and the RAM 1113 may be interconnected with one another via an internal bus.

The controller 1110 may control the mobile communicator 1120, the sub-communicator 1130, the multimedia module 1140, the power supply 1180, the transparent display 1190, and the display controller 1195.

The mobile communicator 1120 may allow the first display apparatus 110 to be connected to the external device via mobile communication by using one or more antennas under the control of the controller 1110. The mobile communicator 1120 may receive/transmit wireless signals for making a call or video call or sending a text message (SMS) or multimedia message (MMS) from/to a mobile phone, a smart phone, a tablet PC, or another device.

The sub-communicator 1130 may include at least one of the wireless LAN device 1131 and the short distance communicator 1132. For example, the sub-communicator 1130 may only include the wireless LAN device 1131 or the short distance communicator 1132 or may include both the wireless LAN device 1131 and the short distance communicator 1132.

The wireless LAN device 1131 may be connected to the Internet at a location where a wireless access point (AP) is installed in accordance with the control of the controller 1110. The wireless LAN device 1131 may support a wireless LAN standard (IEEE802.11x) of the Institute of Electrical and Electronics Engineers (IEEE). The short distance communicator 1132 may perform short distance communication between the first display apparatus 110 and an image forming apparatus in a wireless manner in accordance with the control of the controller 1110. A short distance communication method may include, for example, a Bluetooth™ method, an Infrared Data Association (IrDA) method, a Near Field Communication (NFC) method, a ZigBee method, or the like.

According to an exemplary embodiment, the first display apparatus 110 may detect the second display apparatus by using the short distance communicator 1132. For example, when radio frequency (RF) data indicating the second display apparatus is received by the short distance communicator 1132 through NFC that enables communication within several cm, the first display apparatus 110 may detect that the second display apparatus is close or adjacent to the first display apparatus 110.

According to performance of the first display apparatus 110, the first display apparatus 110 may include at least one of the mobile communicator 1120, the wireless LAN 1131, and the short distance communicator 1132.

The multimedia module 1140 may include the broadcasting communicator 1141, the audio reproducer 1142, or the video reproducer 1143. The broadcasting communicator 1141 may receive a broadcasting signal (e.g., a TV broadcasting signal, a radio broadcasting signal, or a data broadcasting signal) and additional broadcasting information (e.g., an electric program guide (EPG) or an electric service guide (ESG)). The audio reproducer 1142 may reproduce a digital audio file that is stored or received according to the control of the controller 1110. The video reproducer 1143 may reproduce a digital video file that is stored or received according to the control of the controller 1110. The video reproducer 1143 may reproduce a digital audio file.

The multimedia module 1140 may include the audio reproducer 1142 and the video reproducer 1143 except for the broadcasting communicator 1141. Also, the audio reproducer 1142 or the video reproducer 1143 of the multimedia module 1140 may be included in the controller 1110.

The GPS 1150 receives a radio wave from GPS satellites circulating the earth's orbit and may calculate a location of the first display apparatus 110 by using a time of arrival (TOA) of signals from the GPS satellites to the first display apparatus 110.

The inputter/outputter 1160 may include at least one of the button 1161, the microphone 1162, the speaker 1163, the vibration motor 1164, the connector 1165, and the keypad 1166.

The button 1161 may be positioned on a front, side, or rear surface of the first display apparatus 110 and may include at least one of a power/lock button, a volume button, a menu button, a home button, a back button, and a search button.

The microphone 1162 may generate an electrical signal by receiving a voice or sound in accordance with the control of the controller 1110.

The speaker 1163 may output sounds corresponding to various signals of the mobile communicator 1120, the sub-communicator 1130, the multimedia module 1140, or the camera module in accordance with the control of the controller 1110 to the outside of the first display apparatus 110. The speaker 1163 may output a sound corresponding to a function of the first display apparatus 110. There may be one or more speakers 1163 at an appropriate location or appropriate locations of a housing of the first display apparatus 110.

The vibration motor 1164 may convert an electrical signal to a mechanical signal in accordance with the control of the controller 1110. For example, when a voice call is received from another device, the vibration motor 1164 of the first display apparatus 110 in a vibration mode may operate. The vibration motor 1164 may operate in response to a user's motion of touching the transparent display 1190 or continuous touches of the user on the transparent display 1190.

The connector 1165 may be used as an interface for connecting the first display apparatus 110 to an external device or a power source. The connector 1165 may receive/transmit data stored in the storage 1175 of the first display apparatus 110 from/to the external device via wired cables connected to the connector 1165 in accordance with the control of the controller 1110. Power may be applied to the connector 1165 from a power source, or a battery may be charged via the wired cables connected to the connector 1165.

The keypad 1166 may receive a key input from a user in order to control the first display apparatus 110. The keypad 1166 includes a physical keypad formed on the first display apparatus 110 or a virtual keypad displayed on the transparent display 1190. The physical keypad formed on the first display apparatus 110 may be excluded, depending on the performance or a structure of the first display apparatus 110.

The sensors 1170 include at least one sensor for detecting a state of the first display apparatus 110. For example, the sensors 1170 may include a proximity sensor for detecting whether the user is close to the first display apparatus 110, an illumination sensor for detecting an amount of light around the first display apparatus 110, or a motion sensor for detecting a motion of the first display apparatus 110 (e.g., rotation of the first display apparatus 110, vibration or acceleration of the first display apparatus 110, etc.). A sensor of the sensors 1170 may be excluded, depending on the performance of the first display apparatus 110.

The storage 1175 may store a signal or data that is input/output corresponding to motions of the mobile communicator 1120, the sub-communicator 1130, the multimedia module 1140, the camera module, the GPS 1150, the inputter/outputter 1160, the sensors 1170, and the transparent display 1190 in accordance with the control of the controller 1110. The storage 1175 may store a control program or applications for controlling the first display apparatus 110 or the controller 1110.

The term “storage” may include the storage 1175, the ROM 1112, and the RAM 1113 included in the controller 1110, or a memory card mounted in the first display apparatus 110. The storage 1175 may include a non-volatile memory, a volatile memory, a hard disk drive (HDD), or a solid state drive (SSD).

The power supply 1180 may supply power to at least one battery arranged in a housing of the first display apparatus 110 in accordance with the control of the controller 1110. Also, the power supply 1180 may supply each component of the first display apparatus 110 with power that is input from an external power source via the wired cables connected to the connector 1165.

The transparent display 1190 may allow light to pass therethrough and may output an image or graphic user interface (GUI). The transparent display 1190 may display an image, since transparent emission devices are arranged on a transparent substrate. The transparent display 1190 may be embodied in various forms. For example, the transparent display 1190 may be a flexible display or foldable display. Also, the transparent display 1190 may include one or more display devices.

The transparent display 1190 may be a touch screen capable of receiving a touch input. The transparent display 1190 may transmit to the display controller 1195 an analog signal corresponding to a received touch. The touch screen may receive at least one touch input through a body part of the user (e.g., a finger) or a tool (e.g., a stylus pen) capable of touching the touch screen. Also, the transparent display 1190 may receive continuous motions of at least one touch input. The transparent display 1190 may transmit analog signals corresponding to the continuous motions of the at least one touch input.

In the specification, the touch input is not limited to a direct touch input received from the transparent display 1190 by using a body part or the like and may include a proximity touch input (for example, a distance of less than 1 mm between the transparent display 1190 and a body part). A distance detectable from the transparent display 1190 may vary according to the performance or structure of the first display apparatus 110.

The transparent display 1190 that may receive a touch input may be embodied using various methods. For example, the transparent display 1190 may receive a touch input by a resistive method, a capacitive method, an infrared method, a method using a tactile sensor, or an ultrasound-wave method.

When the transparent display 1190 receives a touch input, the first display apparatus 110 may detect that the second display apparatus is close or adjacent to the first display apparatus 110 via the transparent display 1190. For example, when the transparent display 1190 is a touch screen of a capacitive type, if the second display apparatus comes in contact with the transparent display 1190, a current amount in a portion of a surface of the transparent display 1190 where the transparent display 1190 contacts the second display apparatus may change. The first display apparatus 110 may detect that the second display apparatus is close or adjacent to the transparent display 1190 based on an area or shape of the portion where the current amount changes.

The display controller 1195 may convert an analog signal received from the transparent display 1190 into a digital signal (e.g., an X coordinate and a Y coordinate) and may transmit the converted digital signal to the controller 1110. The controller 1110 may control the transparent display 1190 by using the digital signal transmitted by the display controller 1195.

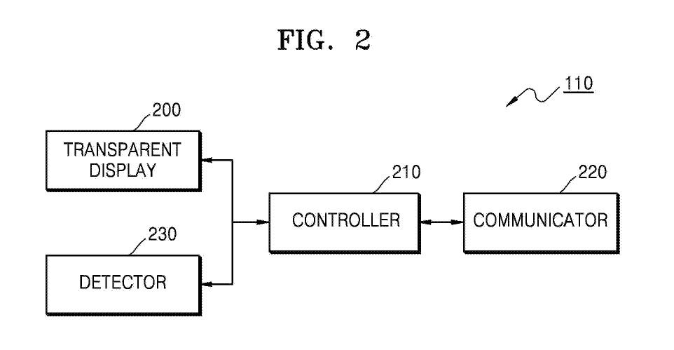

FIG. 2 illustrates a schematic block diagram of the structure of the first display apparatus 110 according to an exemplary embodiment.

The first display apparatus 110 according to an exemplary embodiment may include a transparent display 200, a detector 230, a communicator 220, and a controller 210.

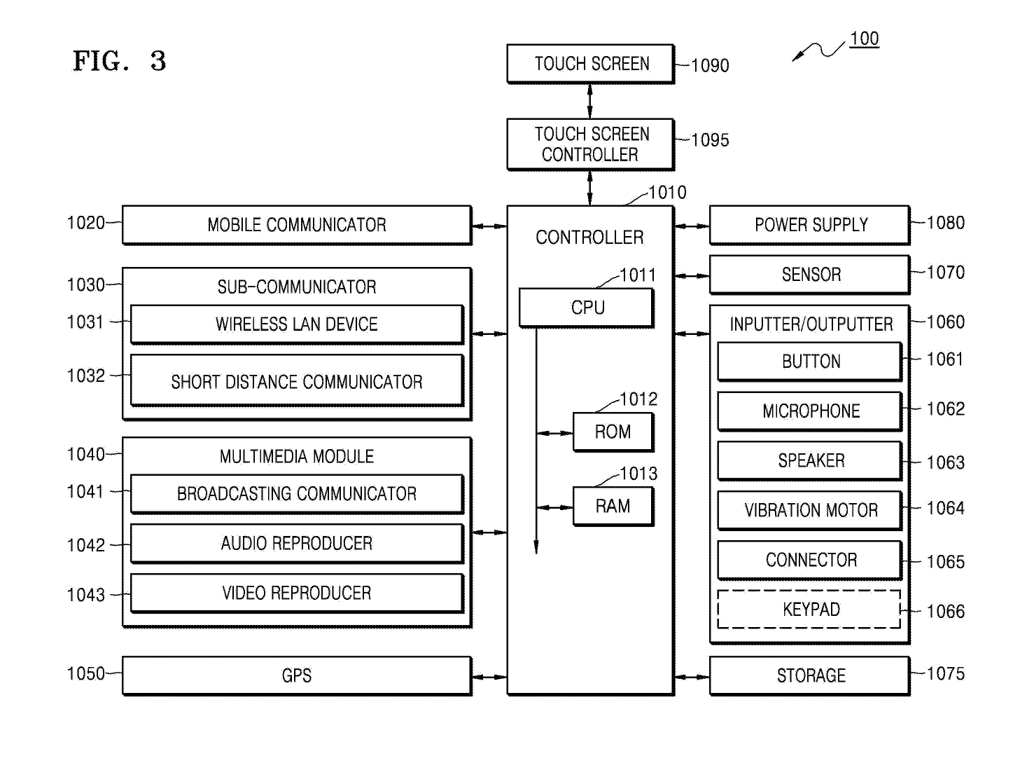

The transparent display 200 may pass light therethrough and may display an image or GUI. Also, according to some exemplary embodiments, the transparent display 200 may receive a user input. For example, the user input may be an analog signal generated by the transparent display 200 when a body part of the user contacts the transparent display 200 or when the second display apparatus 100 of FIG. 3 is close or adjacent to the transparent display 200. Alternatively, the user input may be a digital signal converted from an analog signal. For example, the user input may be a touch input with regard to the transparent display 200. The touch input may vary, for example, “dragging”, “a double touch” of repeatedly contacting the same location of a display apparatus, a touch input of contacting a location of a display apparatus for a long time, or the like. According to exemplary embodiments, the transparent display 200 of FIG. 2 may include the transparent display 1190 and the display controller 1195 of FIG. 1. In the specification, the user input may be a touch input as well as an arbitrary input for selecting an object to be shared between the first display apparatus 110 and the second display apparatus 100.

The detector 230 may detect the second display apparatus 100 that is close or adjacent to the first display apparatus 110. The detector 230 may be variously embodied according to exemplary embodiments. For example, the detector 230 may detect that the second display apparatus 100 is close or adjacent to the first display apparatus 110 by using the transparent display 200 that may receive a touch input. Alternatively, the detector 230 may detect that the second display apparatus 100 is close or adjacent to the first display apparatus 110 when short distance communication with the second display apparatus is performed by using a short distance communicator capable of performing short distance communication. The detector 230 may be included in the transparent display 200 or the communicator 220, according to exemplary embodiments.

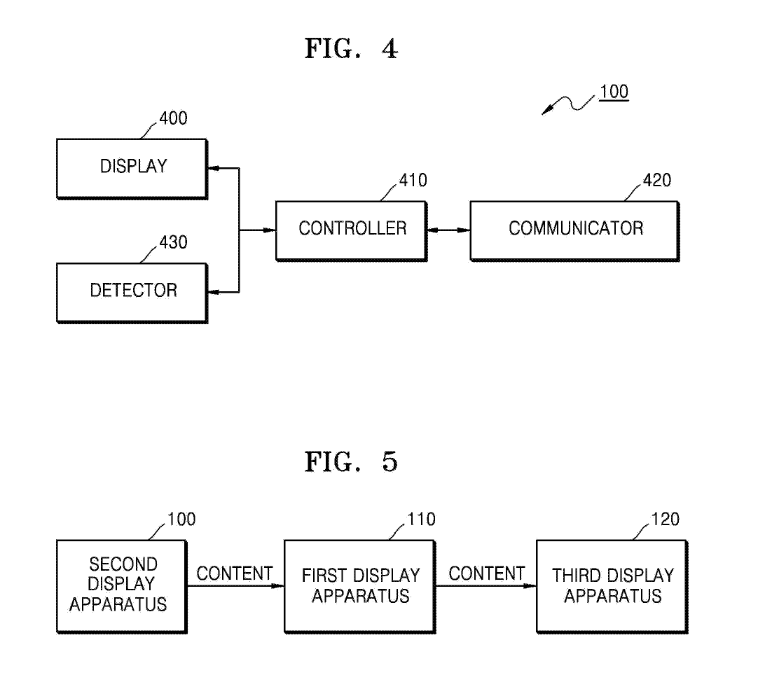

The communicator 220 may perform communication with an external device such as the second display apparatus 100. In particular, when the detector 230 detects that the second display apparatus 100 is close or adjacent to the first display apparatus 110, the communicator 220 may form a communication link with the second display apparatus 100. The communication link refers to a physical medium of connecting at least two nodes for the purpose of receiving/transmitting information. The communication link may include any wired or wireless media suitable for the receiving/transmitting of information. For example, the communicator 220 and the second display apparatus 100 may be paired to perform Bluetooth communication therebetween. According to some exemplary embodiments, the transparent display 200 may receive a user input in an overlapping area on the transparent display 200. The overlapping area may be an area where the transparent display 200 overlaps a display 400 of FIG. 4 of the second display apparatus 100, as described below. In some exemplary embodiments, the overlapping area of transparent display 200 may correspond with an overlapped area of display 400. That is, the overlapping area may be an area where the transparent display 200 is close or adjacent to the display 400. The overlapping area may be the entire transparent display 200 or a portion of the transparent display 200.

The controller 210 may control each component of the first display apparatus 110. When a user input is received in the overlapping area of the transparent display 200, the controller 210 may determine an object corresponding to the user input. For example, according to a location where the user input is received, the controller 210 may select an object displayed on the location where the user input is received. Also, the controller 210 according to other exemplary embodiments may determine whether the object is displayed on the transparent display 200 or the second display apparatus 100. As a result, the controller 210 may determine whether to transmit a request regarding the object to the second display apparatus 100 or provide the object displayed on the transparent display 200 to the second display apparatus 100.

As the user input is received in the overlapping area of the transparent display 200, the communicator 220 may transmit the request regarding the object corresponding to the user input to the second display apparatus 100 via the communication link. According to some exemplary embodiments, when the object corresponding to the user input is displayed on the display 400 of the second display apparatus 100, the communicator 220 may transmit the request to the second display apparatus 100. The controller 210 may obtain data corresponding to the request as a response to the transmitted request via the communicator 220.

When the user input is received through the transparent display 200, the controller 210 may obtain a coordinate value corresponding to the location where the user input is received. The controller 210 may control the communicator 220 to transmit the coordinate value that is obtained together with the request to the second display apparatus 100 such that data about an object that the first display apparatus desires to obtain may be specified. Here, location information about the transparent display 200 and location information about the second display apparatus 100 may be mapped to each other such that the second display apparatus 100 may detect a location of the user input received through the transparent display 200. According to some exemplary embodiments, the controller 210 may map the location information about the transparent display 200 into the location information about the second display apparatus 100. In this case, the communicator 220 may transmit, to the second display apparatus 100, the location information about the second display apparatus 100 that is mapped to the location where the user input is received. Alternatively, according to other exemplary embodiments, when the communicator 220 transmits information about the location where the user input is received to the second display apparatus 100, the second display apparatus 100 may determine the location information about the second display apparatus 100 that corresponds to the information about the location where the user input is received.

Data obtained by the controller 210 through the communicator 220 may vary according to exemplary embodiments.

For example, when the object displayed on the second display apparatus 100 is an application execution icon installed in the second display apparatus 100, the controller 210 may obtain an installation file for installing an application that is the same as the application installed in the second display apparatus 100. A method of obtaining the installation file may vary according to exemplary embodiments. According to some exemplary embodiments, the installation file may be directly received from the second display apparatus 100 via the communicator 220. Alternatively, according to other exemplary embodiments, after receiving an address for downloading the installation file from the second display apparatus 100, the controller 210 may obtain the installation file from a separate server by using the received address. The controller 210 that obtains the installation file may install an application by using the installation file. As the application is installed, the controller 210 may control the transparent display 200 such that the application execution icon may be displayed on the transparent display 200. Also, according to other exemplary embodiments, the controller 210 obtains the application execution icon or an image, in which an application execution screen is captured, instead of the application execution file and may display the obtained application execution icon or image on the transparent display 200.

As another example, when the object displayed on the second display apparatus 100 is a widget, the controller 210 may obtain data such as an image of capturing a displayed widget, a widget installation file, or address information of the widget installation file for installing the widget. The controller 210 that obtains the data may control the first display apparatus 110 such that the widget may be installed in the first display apparatus 110 or a widget execution screen may be displayed on the first display apparatus 110.

As another example, the object displayed on the second display apparatus 100 may be a static image. The controller 210 may obtain a static image displayed on the second display apparatus 100 or data related to the static image. Alternatively, when the object displayed on the second display apparatus 100 is a moving image, the controller 210 may obtain an entire moving image that is reproduced in the second display apparatus 100, some sections of the moving image, a static image of a section of the moving image, or a thumbnail. Alternatively, the controller 210 may obtain a screen shot of an entire screen of the second display apparatus 100.

Alternatively, when the second display apparatus 100 reproduces streaming content, the controller 210 may obtain uniform resource locator (URL) information of the streaming content or information related to the streaming content, for example, metadata.

As another example, when the object displayed on the second display apparatus 100 is contact information such as a phone number, the controller 210 may obtain the contact information as data. In this case, the controller 210 receives a command for controlling the first display apparatus 110 and may call the phone number or display a message writing screen on the first display apparatus 110 by executing the command.

As another example, when a playlist of audio content is displayed on the second display apparatus 100, the controller 210 may obtain at least one of the playlist and audio content included in the playlist. The object is not limited to an image displayed on the second display apparatus 100. For example, when the transparent display 200 comes close to or is adjacent to the first display apparatus 100 while the second display apparatus 100 keeps reproducing the audio content, the controller 210 may obtain the audio content being reproduced by the second display apparatus 100.

Also, according to some exemplary embodiments, the first display apparatus 110 may perform a security authentication process based on a user input that is received when the second display apparatus 100 is close or adjacent to the first display apparatus 110. For example, the user may input a security pattern on the transparent display 200 while viewing a background image displayed on the second display apparatus 100 through the first display apparatus 100. The first display apparatus 110 may perform the security authentication process by transmitting the input security pattern to the second display apparatus 100 or an authentication server.

FIG. 3 illustrates a block diagram of a structure of the second display apparatus 100 according to an exemplary embodiment. FIG. 3 illustrates the second display apparatus 100 according to an exemplary embodiment, but the second display apparatus according to one or more exemplary embodiments of the present disclosure may include more or less components than the second display apparatus 100 of FIG. 3. The second display apparatus 100 may include a device including a display, for example, a mobile phone, a smart phone, a tablet PC, a laptop, an e-book terminal, a digital broadcasting terminal, a PDA, a PMP, a navigation device, a TV, a PC, or the like.

The second display apparatus 100 may be connected to an external device by using a mobile communicator 1020, a sub-communicator 1030, and a connector 1065. The external device may be the first display apparatus 110 of FIG. 5. Alternatively, the external device may include at least one of a mobile phone, a smart phone, a tablet PC, and a server.

Referring to FIG. 3, the second display apparatus 100 may include a touch screen 1090 and a touch screen controller 1095. According to exemplary embodiments, the touch screen 1090 may be replaced by a display capable of performing a display function but not a function of receiving a touch input. Also, the second display apparatus 100 may include at least one of a controller 1010, the mobile communicator 1020, the sub-communicator 1030, a multimedia module 1040, a GPS 1050, an inputter/outputter 1060, a sensors 1070, a storage 1075, and a power supply 1080. The sub-communicator 1030 may include at least one of a wireless LAN 1031 and a short distance communicator 1032. The multimedia module 1040 may include at least one of a broadcasting communicator 1041, an audio reproducer 1042, and a video reproducer 1043. The inputter/outputter 1060 may include at least one of a button 1061, a microphone 1062, a speaker 1063, a vibration motor 1064, a connector 1065, and a keypad 1066.

The controller 1010 may include a CPU 1011, ROM 1012 that stores a control program for controlling the first display apparatus 110, and RAM 1013 that stores a signal or data that is input from the outside of the first display apparatus 110 or is used as a memory space for performing operations in the first display apparatus 110. The CPU 1011, the ROM 1012, and the RAM 1013 may be interconnected with one another via an internal bus.

The controller 1010 may control the mobile communicator 1020, the sub-communicator 1030, the multimedia module 1040, a camera module, the GPS 1050, the inputter/outputter 1060, the sensors 1070, the storage 1075, the power supply 1080, the transparent display 1090, and the display controller 1095.

The mobile communicator 1020 may allow the second display apparatus 100 to be connected to the external device via mobile communication by using one or more antennas under the control of the controller 1010. The mobile communicator 1020 may receive/transmit wireless signals for making a call or video call or sending a text message (SMS) or multimedia message (MMS) from/to a mobile phone, a smart phone, a tablet PC, and another device corresponding to a phone number input to the second display apparatus 100.

The sub-communicator 1030 may include at least one of the wireless LAN device 1031 and the short distance communicator 1032. For example, the sub-communicator 1030 may only include the wireless LAN device 1031 or the short distance communicator 1032 or may include both the wireless LAN device 1031 and the short distance communicator 1032.

The wireless LAN device 1031 may be connected to the Internet at a location where a wireless AP is installed in accordance with the control of the controller 1010. The wireless LAN device 1031 may support a wireless LAN standard (IEEE802.11x) of IEEE. The short distance communicator 1032 may perform short distance communication between the second display apparatus 100 and an image forming apparatus in a wireless manner in accordance with the control of the controller 1010. A short distance communication method may include, for example, a Bluetooth™ method, an IrDA method, an NFC method, a ZigBee method, or the like.

According to an exemplary embodiment, the second display apparatus 100 may detect the first display apparatus 110 by using the short distance communicator 1032. For example, when RF data indicating the first display apparatus 110 is received by the short distance communicator 1032 through NFC that enables communication within several cm, the second display apparatus 100 may detect that the first display apparatus 110 comes close or is adjacent to the second display apparatus 100.

The second display apparatus 100 may include at least one of the mobile communicator 1020, the wireless LAN device 1031, and the short distance communicator 1032 according to performance of the second display apparatus 100.

The multimedia module 1040 may include the broadcasting communicator 1041, the audio reproducer 1042, or the video reproducer 1043. The broadcasting communicator 1041 may receive a broadcasting signal (e.g., a TV broadcasting signal, a radio broadcasting signal, or a data broadcasting signal) and additional broadcasting information (e.g., an EPG or an ESG) transmitted by a broadcasting station via a broadcasting communication antenna according to the control of the controller 1010. The audio reproducer 1042 may reproduce a digital audio file that is stored or received according to the control of the controller 1010. The video reproducer 1043 may reproduce a digital video file that is stored or received according to the control of the controller 1010. The video reproducer 1043 may reproduce a digital audio file.

The multimedia module 1040 may include the audio reproducer 1042 and the video reproducer 1043 except for the broadcasting communicator 1041. Also, the audio reproducer 1042 or the video reproducer 1043 of the multimedia module 1040 may be included in the controller 1010.

The GPS 1050 receives a radio wave from GPS satellites circulating the earth's orbit and may calculate a location of the first display apparatus 110 by using a time of arrival (TOA) of signals from the GPS satellites to the first display apparatus 110.

The inputter/outputter 1060 may include at least one of the button 1061, the microphone 1062, the speaker 1063, the vibration motor 1064, the connector 1065, and the keypad 1066.

The button 1061 may be positioned on a front, side, or rear surface of the second display apparatus 100 and may include at least one of a power/lock button, a volume button, a menu button, a home button, a back button, and a search button.

The microphone 1062 may generate an electrical signal by receiving a voice or sound in accordance with the control of the controller 1010.

The speaker 1063 may output sounds corresponding to various signals of the mobile communicator 1020, the sub-communicator 1030, the multimedia module 1040, or the camera module in accordance with the control of the controller 1010 to the outside of the second display apparatus 100. The speaker 1063 may output a sound corresponding to a function of the second display apparatus 100. There may be one or more speakers 1063 at an appropriate location or appropriate locations of a housing of the second display apparatus 100.

The vibration motor 1064 may convert an electrical signal to a mechanical signal in accordance with the control of the controller 1010. For example, when a voice call is received from another device, the vibration motor 1064 of the second display apparatus 100 in a vibration mode may operate. The vibration motor 1064 may operate in response to a user's motion of touching the transparent display 1090 or continuous touches of the user on the transparent display 1090.

The connector 1065 may be used as an interface for connecting the second display apparatus 100 to an external device or a power source. The connector 1065 may receive/transmit data stored in the storage 1075 of the second display apparatus 100 from/to the external device via wired cables connected to the connector 1065 in accordance with the control of the controller 1010. Power may be applied to the connector 1065 from a power source, or a battery may be charged via the wired cables connected to the connector 1065.

The keypad 1066 may receive a key input from a user in order to control the second display apparatus 100. The keypad 1066 includes a physical keypad formed on the first display apparatus 110 or a virtual keypad displayed on the transparent display 1190. The physical keypad formed on the second display apparatus 100 may be excluded, depending on the performance or a structure of the second display apparatus 100.

The sensors 1070 includes at least one sensor for detecting a state of the second display apparatus 100. For example, the sensors 1070 may include a proximity sensor for detecting whether the user comes close to the second display apparatus 100, an illumination sensor for detecting an amount of light around the second display apparatus 100, or a motion sensor for detecting a motion of the second display apparatus 100 (e.g., rotation of the second display apparatus 100, acceleration or vibration of the second display apparatus 100, etc.). A sensor of the sensors 1070 may be excluded, depending on the performance of the second display apparatus 100.

The storage 1075 may store a signal or data that is input/output corresponding to motions of the mobile communicator 1020, the sub-communicator 1030, the multimedia module 1040, the camera module, the GPS 1050, the inputter/outputter 1060, the sensors 1070, and the transparent display 1090 in accordance with the control of the controller 1010. The storage 1075 may store a control program or applications for controlling the second display apparatus 100 or the controller 1010.

The term “storage” may include the storage 1075, the ROM 1012 and the RAM 1013 included in the controller 1010, or a memory card mounted in the second display apparatus 100. The storage 1075 may include a non-volatile memory, a volatile memory, a HDD, or an SSD.

The power supply 1080 may supply power to at least one battery arranged in a housing of the second display apparatus 100 in accordance with the control of the controller 1010. Also, the power supply 1080 may supply each component of the second display apparatus 100 with power that is input from an external power source via the wired cables connected to the connector 1065.

The touch screen 1090 may transit an analog signal corresponding to a touch to the touch screen controller 1095. The touch screen 1090 may receive at least one touch input through a body part of the user (e.g., a finger) or an input tool (e.g., a stylus pen) capable of touching the touch screen 1090. Also, the touch screen 1090 may receive continuous motions of the at least one touch input. The touch screen 1090 may transmit analog signals corresponding to the continuous motions of the at least one touch input to the touch screen controller 1095.

In the specification, the touch input is not limited to a direct touch input received from the transparent display 1090 through a body part or the like and may include an indirect input (for example, a distance of less than 1 mm between the transparent display 1090 and a body part). A distance detectable from the transparent display 1090 may vary according to the performance or structure of the second display apparatus 100.

The touch screen 1090 capable of receiving a touch input may be embodied in various forms. For example, the touch screen 1090 may receive a touch input by a resistive method, a capacitive method, an infrared method, a method of using a tactile sensor, or an ultrasound-wave method.

The second display apparatus 100 may detect that the first display apparatus 110 is close or adjacent to the second display apparatus 100 via the touch screen 1090. For example, when the touch screen 1090 is a touch screen of a capacitive type, if the first display apparatus 110 comes in contact with the touch screen 1090, a current amount in a portion of a surface of the touch screen 1090 that contacts the first display apparatus 110 may change. The second display apparatus 100 may detect that the first display apparatus 110 is close or adjacent to the touch screen 1090 based on an area or shape of the portion where the current amount changes.

The display controller 1095 may convert an analog signal received from the transparent display 1090 into a digital signal (e.g., an X coordinate and a Y coordinate) and may transmit the converted digital signal to the controller 1010. The controller 1010 may control the transparent display 1090 by using the digital signal transmitted by the display controller 1095.

FIG. 4 illustrates a schematic diagram of a structure of the second display apparatus 100 according to an exemplary embodiment.

The second display apparatus 100 according to some exemplary embodiments may include a display 400, a detector 430, a communicator 420, and a controller 410.

The display 400 may display a GUI, visual content such as a static image or a moving image, or the like. The GUI or the visual content such as a static or moving image that is displayed on the display 400 may be referred to as an ‘object’. The display 400 may display at least one object. Also, according to exemplary embodiments, the display 400 may include the touch screen 1090 of FIG. 3.

The detector 430 may detect the first display apparatus 110 that is close or adjacent to the second display apparatus 100. The detector 430 may be embodied in various forms according to exemplary embodiments. For example, the detector 430 may detect that the first display apparatus 110 is close or adjacent to the second display apparatus 100 by using the touch screen 1090. Alternatively, the detector 430 may detect that the first display apparatus 110 is close or adjacent to the second display apparatus 100 when short distance communication with the first display apparatus 110 is performed by using the short distance communicator 1032 capable of performing short distance communication. According to exemplary embodiments, the detector 430 may be included in the display 400 or the communicator 420.

The communicator 420 may communicate with the external device such as the first display apparatus 110. In particular, when the detector 430 detects that the first display apparatus 110 is close or adjacent to the second display apparatus 100, the communicator 420 may form a communication link with the first display apparatus 110. The communicator 420 may receive a request from the first display apparatus 110 via the communication link. Here, the request may be related to transmission of an object displayed on the second display apparatus 100.

The controller 410 may control each component of the second display apparatus 100. When the request is received from the first display apparatus 110, an object corresponding to the received request may be selected from among at least one object displayed on the second display apparatus 100. For example, the second display apparatus 100 may receive the request as well as location information from the first display apparatus 110. The location information may be coordinates on the second display apparatus 100 or on the first display apparatus 110. When the location information is the coordinates on the second display apparatus 100, the controller 410 may select an object displayed on the location indicated by the coordinate. Alternatively, when the location information is a coordinate of the first display apparatus 110 on the transparent display 200, the controller 410 may determine a coordinate indicating a location on the second display apparatus 100 that is mapped to the coordinate. The controller 410 may select an object displayed at the location indicated by the determined coordinate.

The controller 410 may control the communicator 420 such that the communicator 420 may provide information about the selected object to the first display apparatus 110. The communicator 420 may directly transmit the information about the selected object to the first display apparatus 110 or provide the information about the selected object to the first display apparatus 110 to the first display apparatus 110 via a network or external server.

The information about the selected object may vary according to exemplary embodiments and a selected object.

For example, when the selected object is an application execution icon installed on the second display apparatus 100, the communicator 420 may transmit an application installation file in the first display apparatus 110 or may transmit information indicating a location of the application installation file in accordance with the control of the controller 410. Similarly, when the selected object is a widget installed in the second display apparatus 100, the communicator 420 may transmit an installation file for installing a widget in the first display apparatus 110 or information indicating a location of the installation file. According to another exemplary embodiment, the controller 410 may transmit an image in which an application execution screen is captured or in which a displayed widget is captured, to the second display apparatus 100 via the communicator 420.

As another example, when the selected object is a static image, information about an object which is provided to the first display apparatus 110 may be the static image itself or information (e.g., contact information related to a picture of a person) that is found by using the static image. Alternatively, when the selected object is a moving image, information about the object may be the entire moving image being reproduced, some sections of the moving image, a static image of a section of the moving image, a thumbnail, or the like. Alternatively, the controller 410 may generate a screen shot of an entire screen that is displayed on the second display apparatus 100 and may provide the generated screen shot to the first display apparatus 110.

Alternatively, when the second display apparatus 100 is reproducing streaming content, the controller 410 may provide the first display apparatus 110 with URL information of the streaming content, information related to the streaming content, for example, metadata, or the like, via the communicator 420.

As another example, when the selected object is contact information such as a phone number, the controller 410 may provide the contact information to the first display apparatus 110 via the communicator 420. Here, the controller 410 may also provide the first display apparatus 110 with a command to perform a function thereof. For example, the controller 410 may transmit, via the communicator 420, a phone number and a command for connecting a phone call by using the phone number via the communicator 420, to the first display apparatus 110.

As another example, when the selected object is a playlist of audio content, the controller 410 may provide the first display apparatus 110 with at least one of the playlist and content included in the playlist via the communicator 420. The object may be an image displayed on the second display apparatus 100, or the like. For example, when the transparent display 200 is close or adjacent to the first display apparatus 110 while the second display apparatus 100 is reproducing the audio content, the controller 410 may provide the first display apparatus 110 with the audio content being reproduced by the second display apparatus 100 via the communicator 420.

Also, according to some exemplary embodiments, the second display apparatus 100 may perform a security authentication process by using the first display apparatus 110 including the transparent display 200. For example, the may display a background image for inputting a security pattern, and the user may input the security pattern on the transparent display 200 while watching the background image through the first display apparatus 110. The security authentication process may be performed by using the security pattern that is input on the first display apparatus 110.

FIG. 5 illustrates a schematic conceptual view of a structure in which content is shared between display apparatuses according to some exemplary embodiments.

According to some exemplary embodiments, the first display apparatus 110 may obtain content from the second display apparatus 100 including a transparent display. FIG. 5 illustrates that the second display apparatus 100 directly transmits the content to the first display apparatus 110, but may indirectly transmit the content to the first display apparatus 110 by using an external server, etc. Also, the content may indicate information related to an object displayed on the second display apparatus 100. For example, when the object displayed on the second display apparatus 100 is an application execution icon, the content may be an installation file for installing an application.

The first display apparatus 110 that obtains the content may provide the obtained content to a third display apparatus 120. That is, when the user wants to move the content from the first display apparatus 110 to the third display apparatus 120, the content may be easily selected by using the first display apparatus 110 including the transparent display 200. Also, the user may easily move the content from the second display apparatus 100 to the third display apparatus 120 by using the first display apparatus 110.

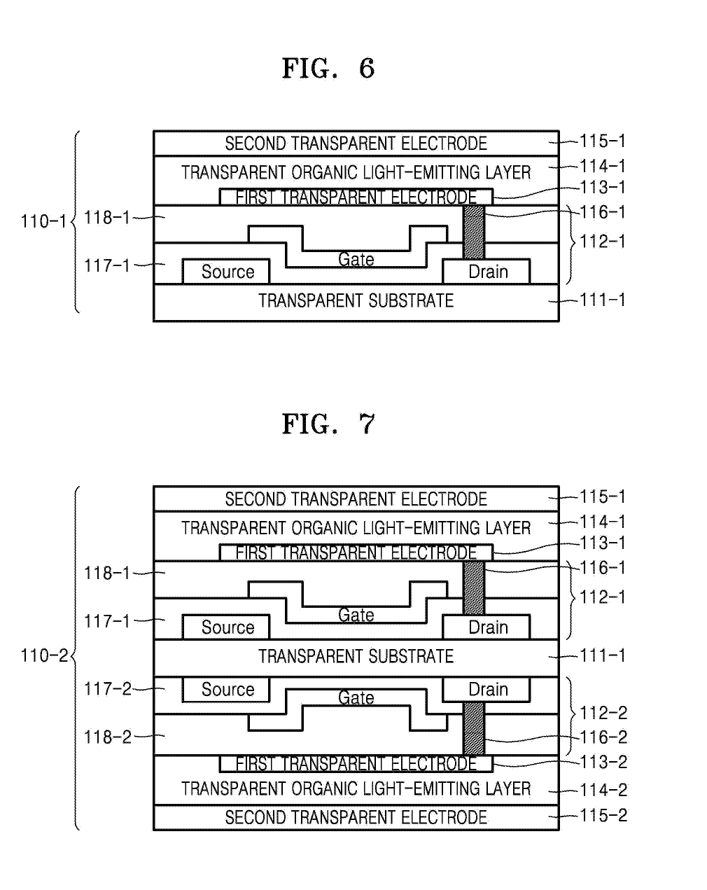

FIG. 6 illustrates a conceptual view of a detailed structure of the transparent display 200 according to some exemplary embodiments. FIG. 6 illustrates the detailed structure of the transparent display 200 embodied as a transparent organic light-emitting display device. The detailed structure of the transparent display 200 may vary according to exemplary embodiments.

A transparent display layer 110-1 forming the transparent display 200 may include a transparent substrate 111-1, a transparent transistor layer 112-1, a first transparent electrode 113-1, a transparent organic light-emitting layer 114-1, a second transparent electrode 115-1, and a connection electrode 116-1.

The transparent substrate 111-1 may be formed of a transparent material (e.g., glass or a polymer such as plastic). A material of the transparent substrate 111-1 may vary, depending on an environment in which the transparent display 200 is used. For example, since a polymer is flexible and light, the polymer may be used in a portable display device, and glass may be used as a smart window included in a show-room window or a shop window.

The transparent transistor layer 112-1 refers to a layer including a transistor in which opaque silicon of an ordinary thin film transistor (TFT) is replaced with a transparent material such as transparent zinc oxide (ZnO) or titanium oxide (TiO₂). The transparent transistor layer 112-1 may include a source, a gate, a drain, and various dielectric layers 117-1 and 118-1. The transparent transistor layer 112-1 may include the connection electrode 116-1 that electrically connects the drain to the first transparent electrode 113-1. Although FIG. 6 illustrates a single transparent transistor having the transparent transistor layer 112-1 including the source, the gate, and the drain, the transparent display 200 may include a plurality of transparent transistors that are evenly distributed over an entire surface of the transparent display 200.

The controller 210 of FIG. 2 scans a cell in which the transparent transistor is arranged by applying an image source signal to the source, the gate, and the drain of each transistor and may display an image by turning on the cell. In detail, the first transparent electrode 113-1 and the second transparent electrode 115-1 may be arranged on opposite sides to each other with respect to the transparent organic light-emitting layer 114-1. The first transparent electrode 113-1, the transparent organic light-emitting layer 114-1, and the second transparent electrode 115-1 may form an organic light-emitting diode (OLED).

The OLED may be classified into a passive matrix OLED (PMOLED) and an active matrix OLED (AMOLED) according to an operation method. The PMOLED has a structure in which a portion where the first transparent electrode 113-1 and the second transparent electrode 115-1 intersect each other forms a pixel. On the contrary, the AMOLED includes a TFT driving each pixel. FIG. 6 illustrates a structure of the AMOLED.

The first transparent electrode 113-1 and the second transparent electrode 115-1 each include a plurality of line electrodes, and alignment directions of the light electrodes of the transparent electrode 113-1 and the second transparent electrode 115-1 may be perpendicular to each other. For example, if the line electrodes of the first transparent electrode 113-1 are aligned in a horizontal direction, the line electrodes of the second transparent electrode 115-1 may be aligned in a vertical direction. Accordingly, the first transparent electrode 113-1 and the second transparent electrode 115-1 may have intersection portions where the first transparent electrode 113-1 and the second transparent electrode 115-1 intersect each other. The transparent transistor of FIG. 6 may be positioned in each intersection portion.

The controller 210 may control transparent transistors in order to generate a potential difference between the intersection portions. When electrons and holes penetrating into the transparent organic light-emitting layer 114-1 from each electrode are combined with each other in the intersection portions having the potential difference therebetween, light may be emitted. On the contrary, intersection portions having no potential difference therebetween may not emit light. Therefore, the intersection portions having no potential difference may remain transparent.

The first transparent electrode 113-1 and the second transparent electrode 115-1 may be formed of indium tin oxide (ITO). Alternatively, the first transparent electrode 113-1 and the second transparent electrode 115-1 may be formed of a novel material such as graphene. The graphene has a honeycomb-shaped planar structure in which carbon atoms are connected to one another, and is transparent. Besides, the transparent organic light-emitting layer 114-1 may be formed of various materials.

FIG. 7 illustrates a conceptual view of a detailed structure of a transparent display including transparent display layers, according to some exemplary embodiments. As illustrated in FIG. 7, the transparent display 200 may include transparent display layers 110-2 having multiple layers.

As in FIG. 6, the transparent display layers 110-2 of FIG. 7 may include a single layer including the transparent substrate 111-1, the transparent transistor layer 112-1, the first transparent electrode 113-1, the transparent organic light-emitting layer 114-1, the second transparent electrode 115-1, and the connection electrode 116-1. Also, the transparent display layers 110-2 may include, with respect to the transparent substrate 111-1, a transparent transistor layer 112-2, a first transparent electrode 113-2, a transparent organic light-emitting layer 114-2, a second transparent electrode 115-2, and a connection electrode 116-2 in an opposite side to the transparent substrate 111-1, the transparent transistor layer 112-1, the first transparent electrode 113-1, the transparent organic light-emitting layer 114-1, the second transparent electrode 115-1, and the connection electrode 116-1.

The transparent transistor layer 112-2 may include a source, a gate, a drain, and various dielectric layers 117-2 and 118-2. The transparent transistor layer 112-1 may include the connection electrode 116-2 that electrically connects the drain to the first transparent electrode 113-2.

When multiple layers are arranged in the transparent display layers 110-2 as illustrated in FIG. 7, the controller 210 may control the transparent display 200 such that the transparent display 200 may display an image in at least one of two directions.

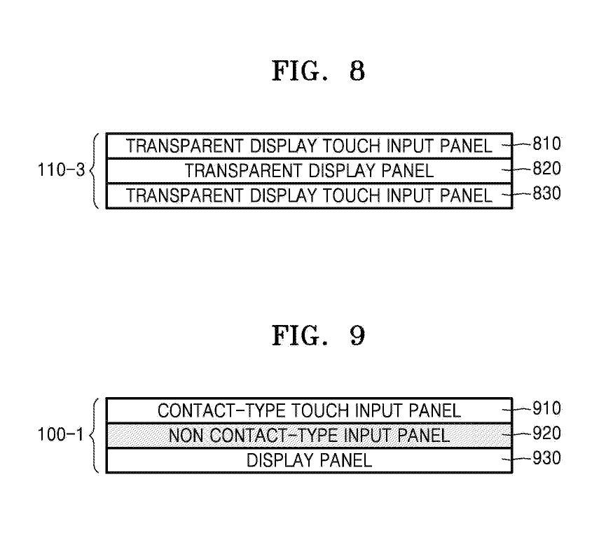

FIG. 8 illustrates a schematic conceptual view of a structure of the transparent display 200 of the first display apparatus 110 according to some exemplary embodiments.

The transparent display 200 may include a transparent touch screen layer 110-3 including a transparent display panel 820, and transparent display touch input panels 810 and 830 respectively arranged on a first surface of the transparent display panel 820 and a second surface opposite the first surface.

The transparent display panel 820 may include the transparent display layer 110-1 of FIG. 6 or the transparent display layers 110-2 of FIG. 7. The transparent display panel 820 may pass light therethrough. The transparent display panel 820 may display an image according to the control of the controller 210.

The transparent display touch input panels 810 and 830 may receive touch inputs. The transparent display touch input panel 810 may receive a touch input from a first surface direction. The transparent display touch input panel 830 may receive a touch input from a second surface direction.

The controller 210 according to some exemplary embodiments may individually activate or inactivate the transparent display touch input panel 810, the transparent display panel 820, and the transparent display touch input panel 830.

FIG. 9 illustrates a schematic conceptual view of a structure of the display 400 of the second display apparatus 100, according to some exemplary embodiments.

The display 400 according to some exemplary embodiments may include a touch screen 100-1 including a contact-type touch input panel 910, a non-contact type input panel 920, and a display panel 930.

The display panel 930 may include an arbitrary display device capable of displaying an image. The display panel 930 may be a transparent display or a non-transparent display. For example, the display panel 930 may include a transparent display or may include a liquid crystal display (LCD) or a plasma display panel (PDP).

The contact-type touch input panel 910 may be an input panel receiving a touch input when a touch input medium (e.g., a finger) directly contacts the input panel. For example, the contact-type touch input panel 910 may be a touch panel using a resistive method, a capacitive method, an infrared method, a method of using a tactile sensor, or an ultrasound-wave method.

The non-contact type input panel 920 may be an input panel capable of receiving a user input even though a touch input medium (e.g., a finger) does not directly touch the input panel. For example, the non-contact type input panel 920 may include a hover panel capable of receiving a hovering input. The hover panel may be a panel receiving a user input by detecting a change of electrostatic capacity on a surface of the panel when the panel comes in contact with the touch input medium.

The controller 410 of FIG. 4 may individually activate or inactivate the contact-type touch input panel 910, the non contact-type input panel 920, and the display panel 930. The controller 410 may only activate the contact-type touch input panel 910 and the display panel 930 in a state in which the transparent display 200 is not close or adjacent to the display 400. Also, the controller 410 may inactivate the non contact-type input panel 920.

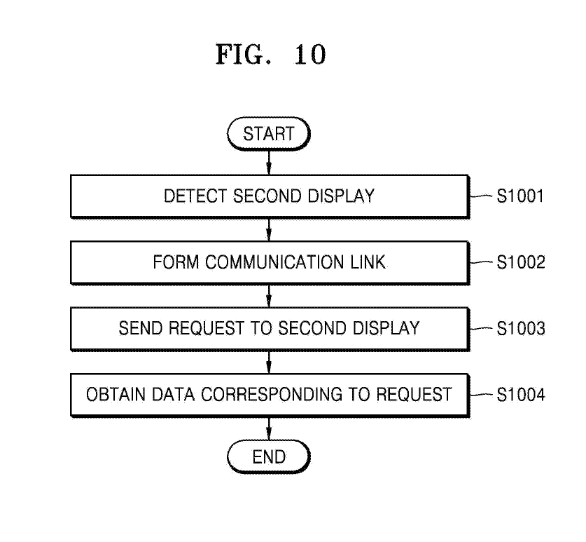

FIG. 10 illustrates a flowchart of a process of controlling the first display apparatus 110, according to some exemplary embodiments.

According to some exemplary embodiments, in operation S1001, the first display apparatus 110 may detect that the second display apparatus 100 is close or adjacent to the first display apparatus 110 by using the detector 230. The detector 230 may detect the second display apparatus 100 by using various methods, according to some exemplary embodiments. For example, the detector 230 may detect that the second display apparatus 100 is close or adjacent to the first display apparatus 110 when communication with the second display apparatus 100 is performed via NFC performed within several cm. As another example, as the second display apparatus 100 contacts a surface of the transparent display 200, if the detector 230 detects that a touch sensor, from among touch sensors arranged on a surface of the transparent display 200, contacts an area that is greater than a threshold area, the detector 230 may detect that the second display apparatus 100 is adjacent to the first display apparatus 110. However, the present exemplary embodiment is not limited thereto.

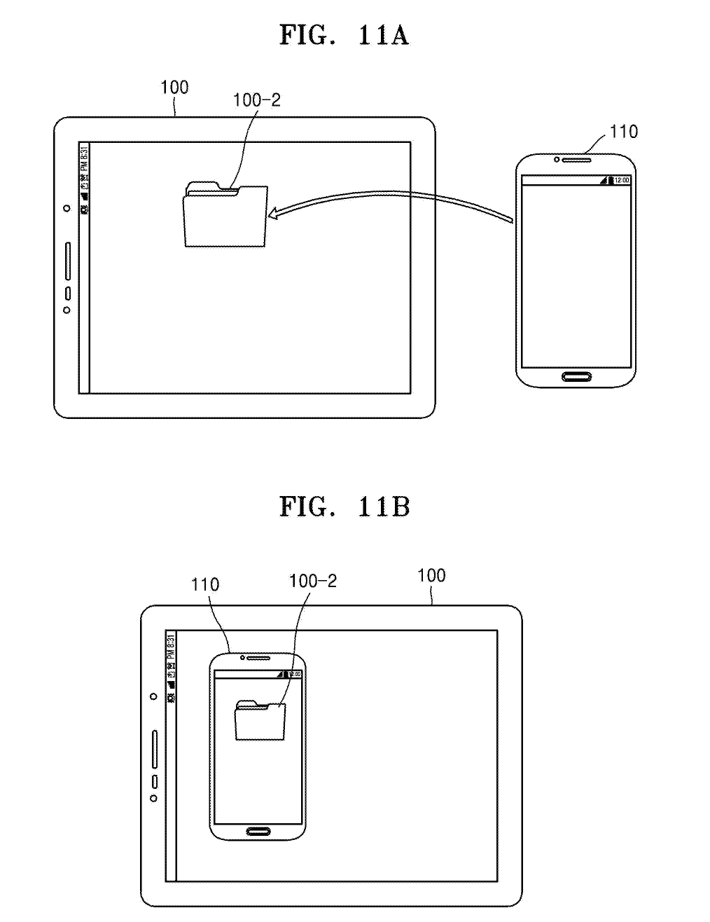

In operation S1001, a state identified by the first display apparatus 110, that is, a state in which “the second display apparatus 100 is close or adjacent to the first display apparatus 110”, may be a state in which the transparent display 200 of the first display apparatus 110 overlaps the display 400 of the second display apparatus 100. For example, referring to FIGS. 11A and 11B illustrating a conceptual view, from a point of view of the user, of an example in which the first display apparatus 110 is close or adjacent to the second display apparatus 100 on which an object is displayed, the second display apparatus 100 may display an object 100-2 as illustrated in FIG. 11A. As illustrated in FIG. 11B, when the first display apparatus 110 is positioned on the second display apparatus 100, the second display apparatus 100 may detect that the first display apparatus 110 is close or adjacent to the second display apparatus 100. Although the first display apparatus 110 is positioned on the second display apparatus 100, the user may watch the object 100-2 through the transparent display 200 of the first display apparatus 110.

Then, the first display apparatus 110 may form a communication link with the second display apparatus 100 via the communicator 220, in operation S1002. According to some exemplary embodiments, the communication link may be a communication link using a short distance communication method.

A method of forming a communication link may vary according to exemplary embodiments. For example, when the first display apparatus 110 detects that the second display apparatus 100 is close or adjacent to the first display apparatus 110, the first display apparatus 110 may receive/transmit, from/to the second display apparatus 100, information (e.g., identification information of a device, a password such as a personal identification number (PIN), or the like) necessary to perform pairing for Bluetooth™ communication using NFC). The first display apparatus 110 may perform pairing for performing Bluetooth™ communication with the second display apparatus 100 based on the received/transmitted information. When the pairing is completed, a communication link between the first display apparatus 110 and the second display apparatus 100 may be formed.

When the communication link with the second display apparatus 100 is formed, the first display apparatus 110 may send a request to the second display apparatus 100 via the communication link, in operation S1003. Here, the request may be related to transmission or reception of data related to an object.

In operation S1003, the first display apparatus 110 may send the request to the second display apparatus 100 as a user input is received. The request may be relate to an object specified by the user input. For example, when the user touches a point on the transparent display 200 for a long time, which can be for example a time that is longer than a predetermined time, the first display apparatus 110 may transmit, to the second display apparatus 100, a request about the object positioned on the display 400 which corresponds to the point touched by the user. Alternatively, when the object displayed on the point of the transparent display 200 which is touched by the user, the first display apparatus 110 may transmit information regarding the displayed object to the second display apparatus 100. According to some exemplary embodiments, the user input may be a user input with regard to an overlapping area. Referring to FIGS. 11A and 11B, when the first display apparatus 110 and the second display apparatus 100 are arranged as illustrated in FIG. 11B, the overlapping area may be an entire area of the transparent display 200 of the first display apparatus 110.

In operation S1004, the second display apparatus 100 may obtain data corresponding to the transmitted request. In operation S1004, the data obtained via the communicator 220 may vary according to exemplary embodiments.

For example, when the object displayed on the second display apparatus 100 is an application execution icon installed in the second display apparatus 100, the controller 210 may obtain an application file for installing an application that is the same as the application installed in the second display apparatus 100. A method of obtaining an installation file may vary according to exemplary embodiments. According to some exemplary embodiments, the installation file may be directly received from the second display apparatus 100 via the communicator 220. Alternatively, according to other exemplary embodiments, after an address for downloading the installation file is received from the second display apparatus 100, the controller 210 may obtain the installation file from a separate server by using the received address. The controller 210 obtaining the installation file may install an application by using the installation file. As the application is installed, the controller 210 may control the transparent display 200 in order to display the application execution icon is displayed on the transparent display 200. Also, according to other exemplary embodiments, the controller 210 may obtain an image in which an application execution screen is captured or an application execution icon instead of the application installation file and may display the image or application execution icon on the transparent display 200.

As another example, when the object displayed on the second display apparatus 100 is a widget, the controller 210 may obtain an image, in which the displayed widget is captured, a widget installation file, or data such as address information of the widget installation file for installing a widget. The controller 210 obtaining the data may control the first display apparatus 110 in order to install the widget or display a widget execution screen on the first display apparatus 110.

As another example, the object displayed on the second display apparatus 100 may be a static image. The controller 210 may obtain the static image displayed on the second display apparatus 100 or data related to the static image. Alternatively, when the object displayed on the second display apparatus 100 is a moving image, the controller 210 may obtain an entire moving image being reproduced by the second display apparatus 100, some sections of the moving image, a static image of capturing the moving image, or a thumbnail. Alternatively, the controller 210 may obtain a screen shot of an entire screen of the moving image displayed on the second display apparatus 100.

Alternatively, when the second display apparatus 100 is reproducing streaming content, the controller 210 may obtain URL information of the streaming content or information related to the streaming content, for example, metadata.

As another example, when the object displayed on the second display apparatus 100 is contact information such as a phone number, the controller 210 may obtain the contact information as data. In this case, the controller 210 receives a command for controlling the first display apparatus 110, and as the command is executed, the controller 210 may make a call or display a screen for writing a message by using the received contact information.

As another example, when a playlist of audio content is displayed on the second display apparatus 100, the controller 210 may obtain at least one of the playlist and audio content included in the playlist. The object is not limited to an image displayed on the second display apparatus 100. For example, when the transparent display 200 is close or adjacent to the first display apparatus 110 while the second display apparatus 100 is reproducing the audio content, the controller 210 may obtain the audio content being reproduced by the second display apparatus 100.

Also, according to some exemplary embodiments, the first display apparatus 110 may perform a security authentication process based on a user input that is received when the second display apparatus 100 is close or adjacent to the first display apparatus 110. For example, the user may input a security pattern on the transparent display 200 while watching a background image displayed on the second display apparatus 100 through the first display apparatus 110. The first display apparatus 110 may perform the security authentication process by transmitting the input security pattern to the second display apparatus 100 or an authentication server.

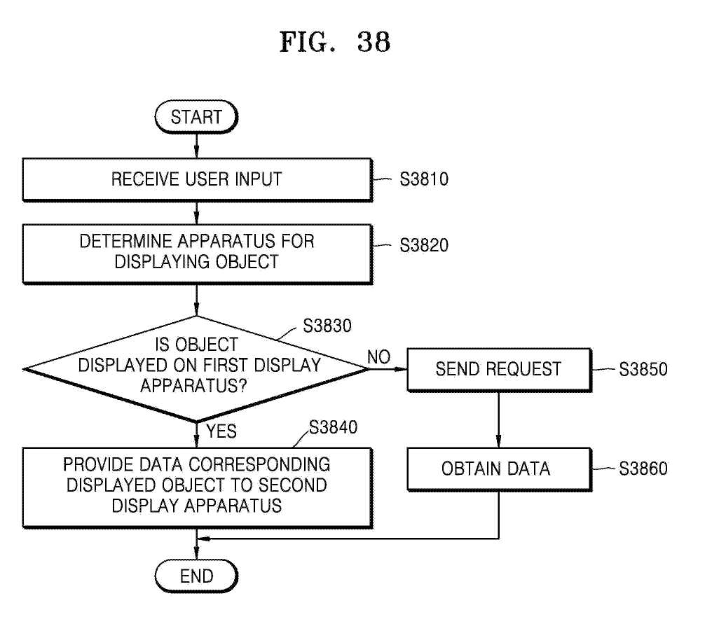

According to other exemplary embodiments, operations S1003 and S1004 may be replaced with operation of providing the second display apparatus 100 with data corresponding to the object displayed on the transparent display 200. This will be described in detail with reference to FIGS. 38 to 40.

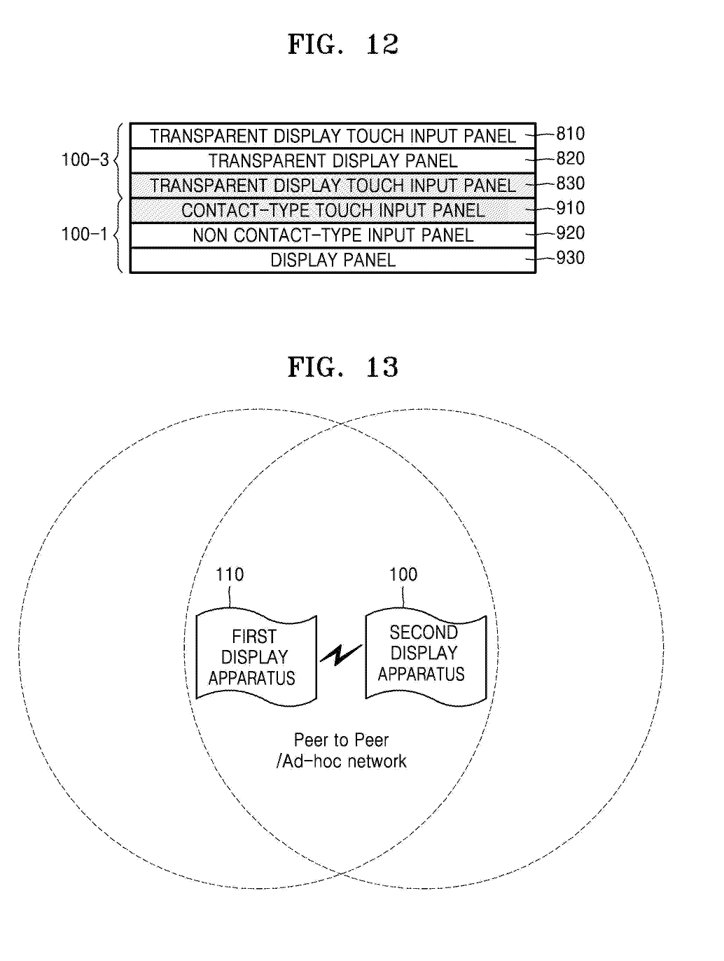

FIG. 12 illustrates a conceptual view for explaining whether components of the first and second display apparatuses 110 and 100 are activated when the first and second display apparatuses 110 and 100 are adjacent to each other.

The transparent display 200 of the first display apparatus 110 and the display 400 of the second display apparatus 100 may respectively be a touch screen. When the transparent display 200 is close or adjacent to the display 400, touch sensors of the transparent display 200 and the display 400 may continue to operate, and as a result, an undesired touch input may be received even though there is no user input.

In order to prevent this, as described above with reference to FIGS. 8 and 9, according to some exemplary embodiments, components of a transparent display layer 110-3 of the transparent display 200 and a touch screen panel 100-1 of the display 400 may be individually activated or inactivated. Therefore, when it is detected that the transparent display 200 is close or adjacent to the display 400, the controller 210 of the first display apparatus 110 may inactivate a transparent display touch input panel 830 on a surface that is close or adjacent to the touch screen panel 100-1. Also, when it is detected that the transparent display 200 is close or adjacent to the display 400, the controller 410 of the second display apparatus 100 may inactivate the contact-type touch input panel 910 and may activate the non contact-type input panel 920. The transparent display touch input panel 810, the transparent display panel 820, and the display panel 930 may remain activated.

As illustrated in FIG. 12, as respective components of the transparent display layer 110-3 and the touch screen panel 100-1 are activated or inactivated, the transparent display 200 and the display 400 may receive a touch input of the user without an operation failure.

According to some exemplary embodiments, the controller 210 may inactivate an overlapping area of the first display apparatus 110 and the second display apparatus 100 from an area of the transparent display touch input panel 830 that is adjacent to the second display apparatus 100. Also, the controller 410 may inactivate an overlapping area of the first display apparatus 110 and the second display apparatus 100 from an area of the contact-type touch input panel 910 and may activate the overlapping area from the non contact-type input panel 920.

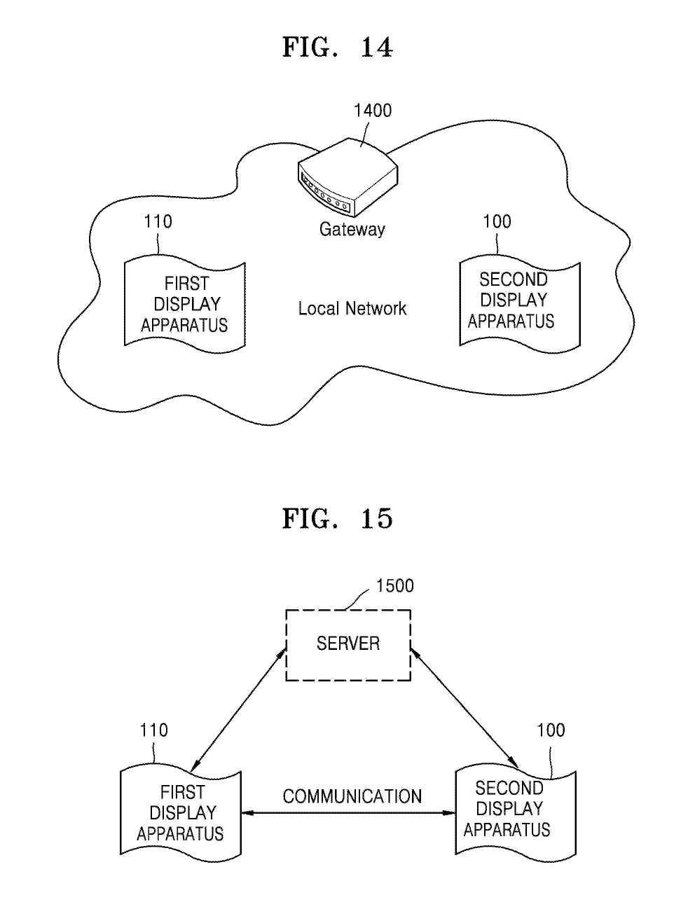

FIGS. 13 and 14 illustrate block diagrams for explaining a communication method of the first display apparatus 110 and the second display apparatus 100 according to some exemplary embodiments. As illustrated in FIG. 13, the first display apparatus 110 and the second display apparatus 100 may receive/transmit data from/to each other by using an Ad hoc method without a separate AP.

In some exemplary embodiments, as illustrated in FIG. 14, the first display apparatus 110 and the second display apparatus 100 may receive/transmit data from/to each other by using a gateway 1400. That is, the first display apparatus 110 and the second display apparatus 100 may receive/transmit data from/to each other by an infrastructure method. The gateway 1400 may function as an AP.

FIG. 15 illustrates a block diagram for explaining a method of obtaining data according to other exemplary embodiments, the method performed by the first display apparatus 110 and the second display apparatus 100.

According to some exemplary embodiments, the first display apparatus 110 may obtain additional data from a server 1500 based on data received from the second display apparatus 100. For example, when the first display apparatus 110 receives an URL indicating a location of an installation file from the second display apparatus 100, the first display apparatus 110 accesses the server 1500 based on the URL and may obtain the installation file from the server 1500. In the specification, the above-described method may be referred to as a pull method.

According to other exemplary embodiments, the second display apparatus 100 does not transmit data to the first display apparatus 110 and may transmit information about the first display apparatus 110 and a data transmission request to the server 1500. In this case, the server 1500 may transmit the data to the first display apparatus 110 in response to the request received from the second display apparatus 100. In the specification, the above-described method may be referred to as a push method.

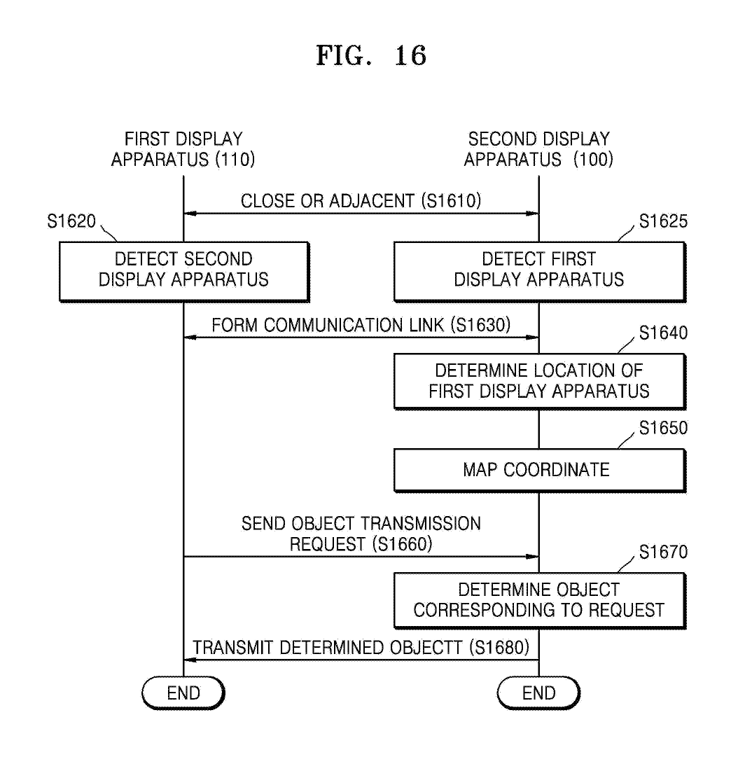

FIG. 16 illustrates a flowchart of a process of receiving an object from the second display apparatus 100 by the first display apparatus 110. According to some exemplary embodiments, the second display apparatus 100 may map a coordinate on the first display apparatus 110 to a coordinate on the second display apparatus 100 in order to determine an object selected by the user.

In operation S1610, the first display apparatus 110 and the second display apparatus 100 may be close or adjacent to each other. In operation S1620, when the first display apparatus 110 and the second display apparatus 100 are close or adjacent to each other, the first display apparatus 110 may detect the second display apparatus 100. Also, the second display apparatus 100 may detect the first display apparatus 110 in operation S1625.

Then, in operation S1630, a communication link may be formed between the first display apparatus 110 and the second display apparatus 100. The communication link is a physical medium connecting at least two points for the purpose of reception/transmission of data. The communication link may include any wired or wireless media suitable for the reception/transmission of data.

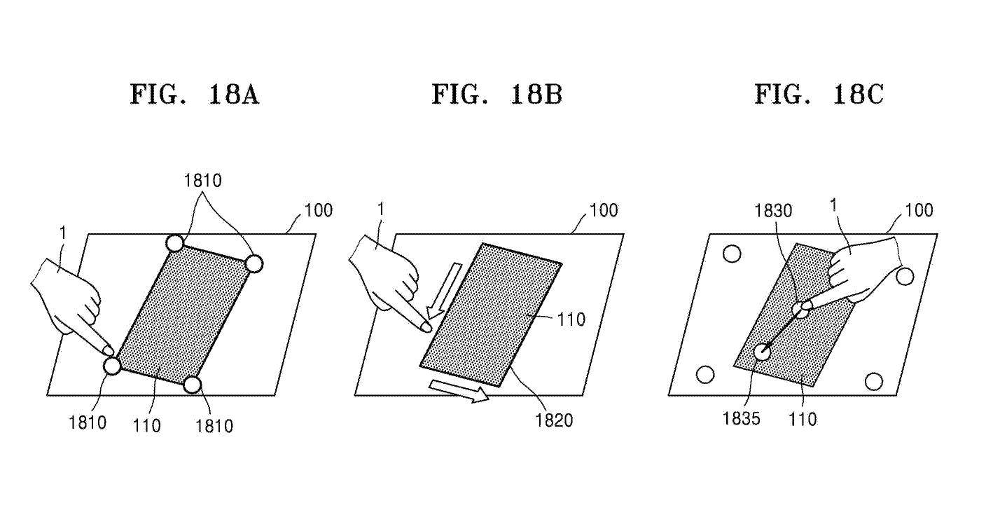

In operation S1640, the second display apparatus 100 may determine a location of the first display apparatus 110. The location of the first display apparatus 110 may be a relative location with respect to the second display apparatus 100. In operation S1640, the second display apparatus 100 may determine an overlapping area thereon. The relative location of the first display apparatus 110 with respect to the second display apparatus 100 may vary according to exemplary embodiments. Some examples of determining a relative location of the first display apparatus 110 with respect to the second display apparatus 100 will be described with reference to FIG. 18 below.

The second display apparatus 100 may map location information of the first display apparatus 110 to location information of the second display apparatus 100 based on the location of the first display apparatus 110 with respect to the second display apparatus 100. That is, in operation S1650, a coordinate indicating a location of the second display apparatus 100 may be mapped to a coordinate indicating the location of the first display apparatus 110.

Then, in operation S1660, the first display apparatus 110 may send a request for transmitting information about an object displayed on the second display apparatus 100 to the second display apparatus 100. In operation S1660, the first display apparatus 110 may receive a user input. Also, the first display apparatus 110 may transmit the coordinate indicating the location of the first display apparatus 110, which receives the user input in operation S1660, as well as the request to the second display apparatus 100.

Then, the second display apparatus 100 may determine the coordinate indicating the location of the second display apparatus 100 which is mapped to the coordinate received from the first display apparatus 110. In operation S1670, the second display apparatus 100 may determine the object displayed on the second display apparatus 100 indicated by the determined coordinate as an object corresponding to the request received in operation S1660.

The second display apparatus 100 may provide the first display apparatus 110 with information about the object. According to some exemplary embodiments, the second display apparatus 100 may transmit the determined object (e.g., an icon) to the first display apparatus 110 in operation S1680. The first display apparatus 110 may display the transmitted object on the transparent display 200.

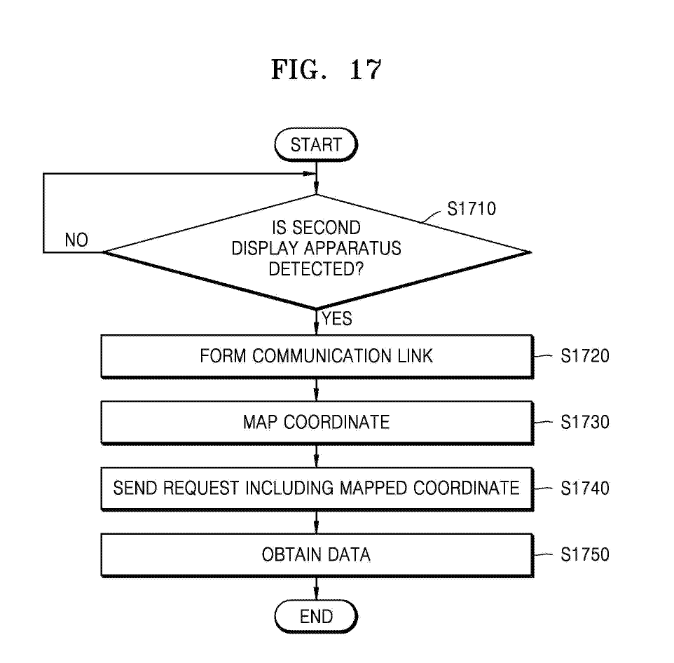

FIG. 17 illustrates a flowchart of a process of controlling the first display apparatus 110 receiving an object from the second display apparatus 100, according to other exemplary embodiments. According to some exemplary embodiments of FIG. 16 and other exemplary embodiments, the first display apparatus 110 may map the coordinate indicating the location of the first display apparatus 110 to the coordinate indicating the location of the second display apparatus 100.

First, when the second display apparatus 100 that is close or adjacent to the first display apparatus 110 is detected in operation S1710, the first display apparatus 110 may form a communication link with the second display apparatus 100 in operation S1720.

In operation S1730, the first display apparatus 110 may map the coordinate indicating the location of the first display apparatus 110 to the coordinate indicating the location of the second display apparatus 100 based on a relative location of the second display apparatus 100 with respect to the first display apparatus 110.

When the first display apparatus 110 receives a user input, the first display apparatus 110 may determine the coordinate indicating the location of the second display apparatus 100 which is mapped to the location of the first display apparatus 110 receiving the user input. In operation S1740, the first display apparatus 110 may transmit the determined coordinate and an object transmission request to the second display apparatus 100. The second display apparatus 100 may select an object displayed at a location indicated by the received coordinate. In operation S1740, the first display apparatus 110 may obtain data regarding the selected object in response to the request transmitted by the second display apparatus 100.

FIGS. 18A to 18C illustrate conceptual views of a method of mapping location information of the first display apparatus 110 to location of the second display apparatus 100, according to some exemplary embodiments. FIGS. 18A to 18C illustrate that in some exemplary embodiments a size of the first display apparatus 110 may be smaller than a size of the second display apparatus 100.

According to some exemplary embodiments, as illustrated in FIG. 18A, the second display apparatus 100 may receive a touch input of touching portions around at least two corners 1810 of the first display apparatus 110. For example, as illustrated in FIG. 18A, when there are four corners 1810 that are input by the user, the second display apparatus 100 may determine a rectangular internal area, which has four corners as vertices, as an overlapping area with respect to the second display apparatus 100. The second display apparatus 100 may map coordinates within the determined overlapping area to a coordinate of the first display apparatus 110 on a transparent display.

In addition, according to other exemplary embodiments, as illustrated in FIG. 18B, the second display apparatus 100 may receive a drag input of the user that moves the first display apparatus 110 along an edge 1820. In this case, the second display apparatus 100 may determine an internal portion of a figure drawn by a trajectory of the drag input as an overlapping area. The second display apparatus 100 may map coordinates within the overlapping area to a coordinate of the first display apparatus 110 on the transparent display.

In addition, according to other exemplary embodiments, as illustrated in FIG. 18C, the first display apparatus 110 displays a first indicator 1835 on the transparent display 200, and the second display apparatus 100 may display a second indicator 1830 on the transparent display 200. The first display apparatus 110 may receive a drag input of the user that connects the first indicator 1835 and the second indicator 1830 on the transparent display 200. The first display apparatus 110 may determine a relative location between the first display apparatus 110 and the second display apparatus 100 based on a start point, an end point, and a direction of the received drag input. The first display apparatus 110 may map coordinates regarding the first display apparatus 110 on the transparent display 200 to coordinates on the second display apparatus 100 based on the relative location between the first display apparatus 110 and the second display apparatus 100. Alternatively, the first display apparatus 110 may transmit, to the second display apparatus 100, vectors indicating the start point, the end point, and the direction of the received drag input. The second display apparatus 100 receiving the vectors may map the coordinates of the first display apparatus 110 on the transparent display to coordinates indicating the location information of the second display apparatus 100.

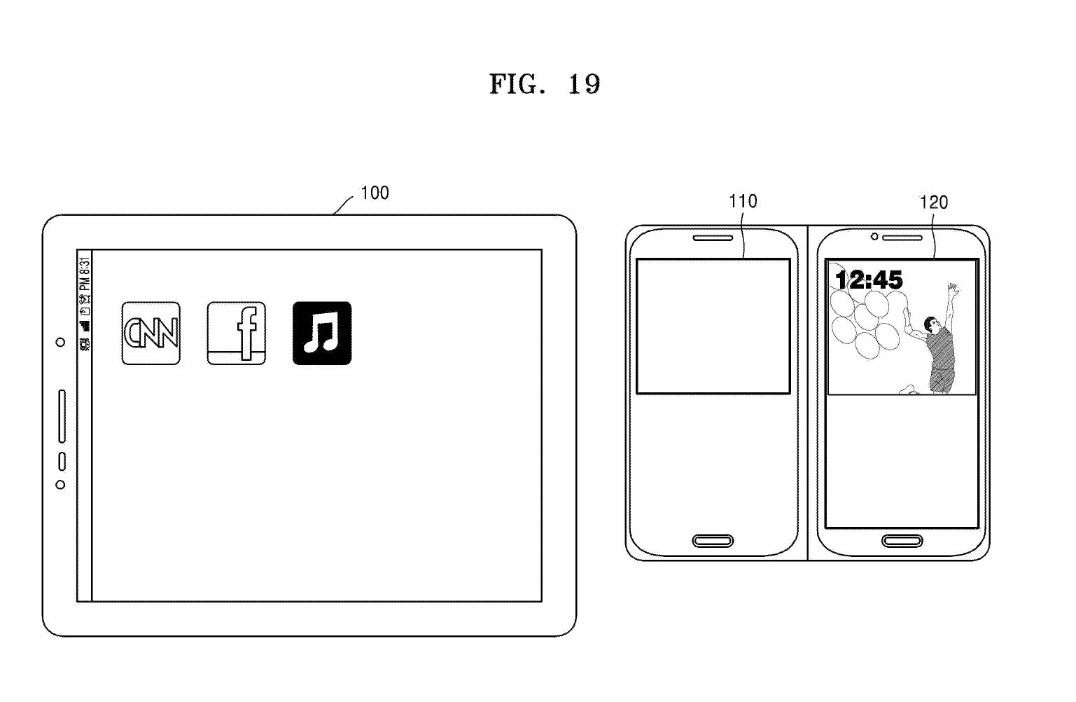

FIGS. 19 to 23 illustrate conceptual views of examples in which an object related to an application displayed on the second display apparatus 100 is obtained.

Referring to FIG. 19, the first display apparatus 110 may include a transparent display included in an external cover of a terminal. Also, the second display apparatus 100 may be tablet PC. Also, the third display apparatus 120 may be a smart phone.

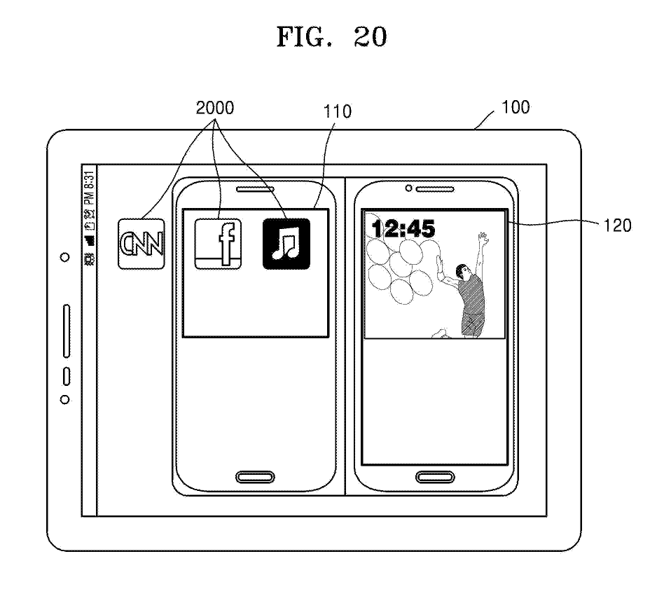

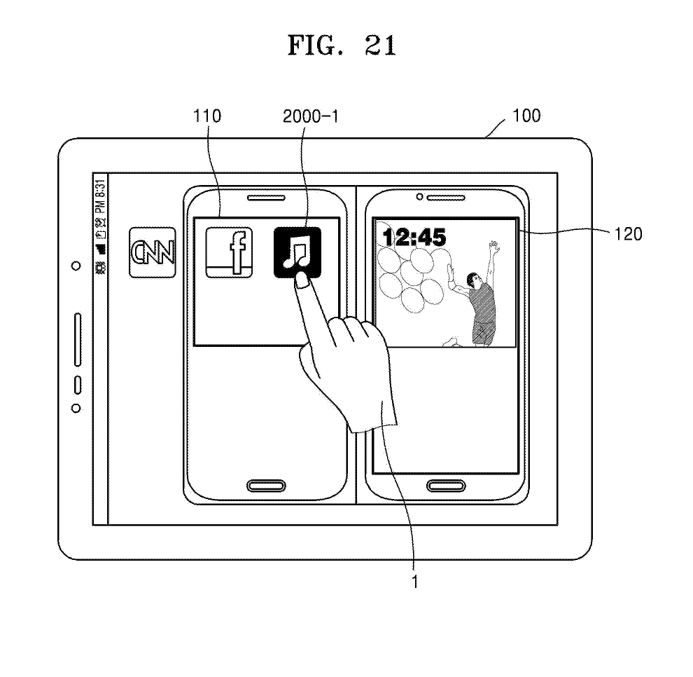

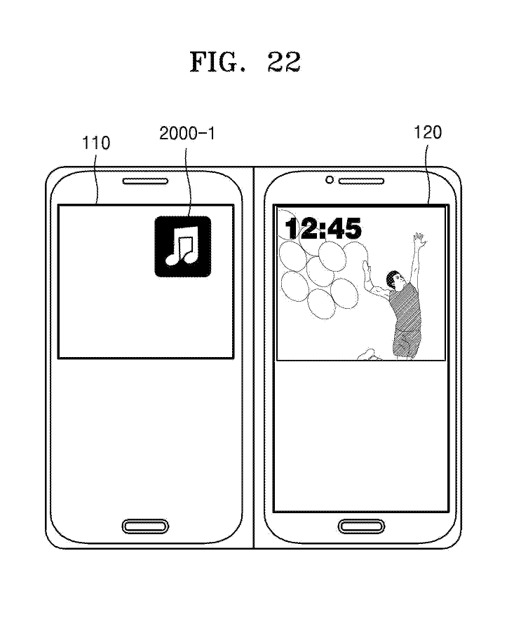

The second display apparatus 100 may display application execution icons 2000. As illustrated in FIG. 20, the first display apparatus 110 may be close or adjacent to the second display apparatus 100. Referring to FIG. 21, when the first display apparatus 110 is close or adjacent to the second display apparatus 100, a user 1 may select (contact) a location, where at least one application execution icon 2000-1 is displayed, with a touch input medium (e.g., a finger) on a transparent display.

When the user 1 selects at least one application execution icon 2000-1, the first display apparatus 110 may obtain data regarding the at least one selected application execution icon 2000-1. The data regarding the at least one application execution icon 2000-1 may be an application installation file regarding the application execution icon 2000-1 or an image of the application execution icon 2000-1. As illustrated in FIG. 22, the first display apparatus 110 that obtained the data regarding the application execution icon 2000-1 may display the application execution icon 2000-1 on the transparent display.

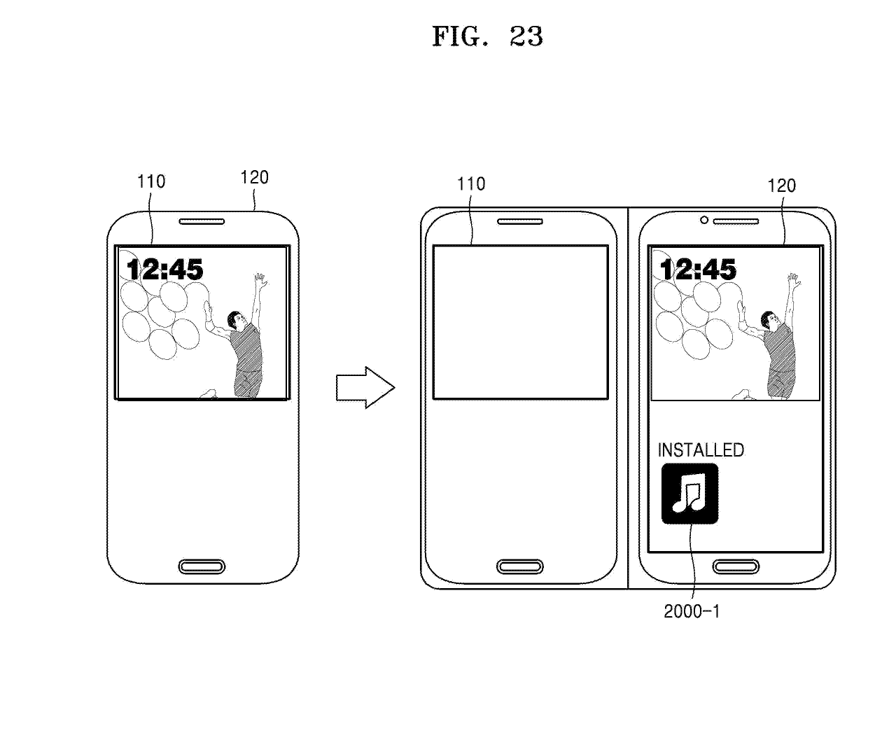

Then, when the user 1 closes the external cover of the terminal including the transparent display forming the first display apparatus 110, the first display apparatus 110 may overlap the third display apparatus 120. As the first display apparatus 110 overlaps the third display apparatus 120, the data regarding the application execution icon 2000-1 may be provided to the third display apparatus 120. According to some exemplary embodiments, as illustrated in FIG. 23, an application may be installed and the application execution icon 2000-1 may be displayed on the third display apparatus 120.

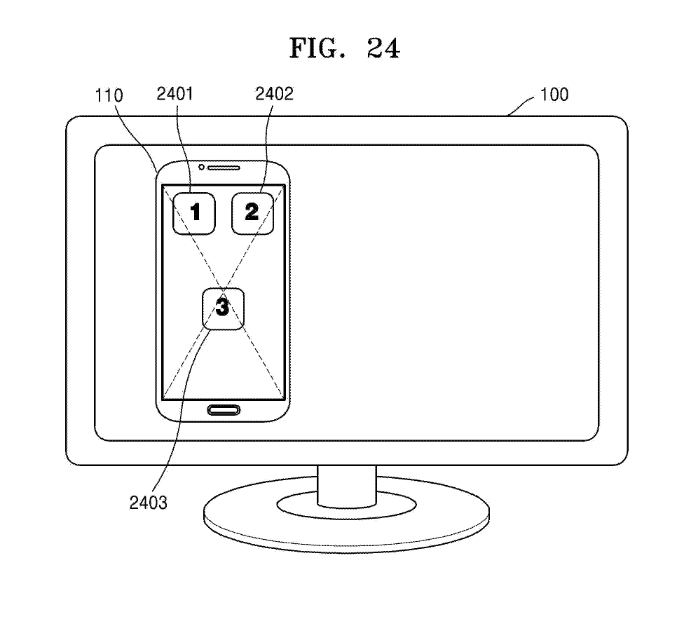

FIG. 24 illustrates a conceptual view of a method of selecting an object displayed on the second display apparatus 100, according to other exemplary embodiments.

According to other exemplary embodiments, when the first display apparatus 110 is positioned on the second display apparatus 100, the first display apparatus 110 may obtain data regarding the object displayed at a location corresponding to a central point of the first display apparatus 110 (or a central point of the transparent display) without any input. Referring to FIG. 24, when the first display apparatus 110 is positioned on the second display apparatus 100 on which objects 2401, 2402, and 2403 are displayed, the first display apparatus 110 may obtain data regarding the object 2403 displayed at a location corresponding to the central point of the first display apparatus 110 (or a central point of the transparent display). The user may change the location of the first display apparatus 110 when the user wants to make the first display apparatus 110 to obtain data regarding other objects.

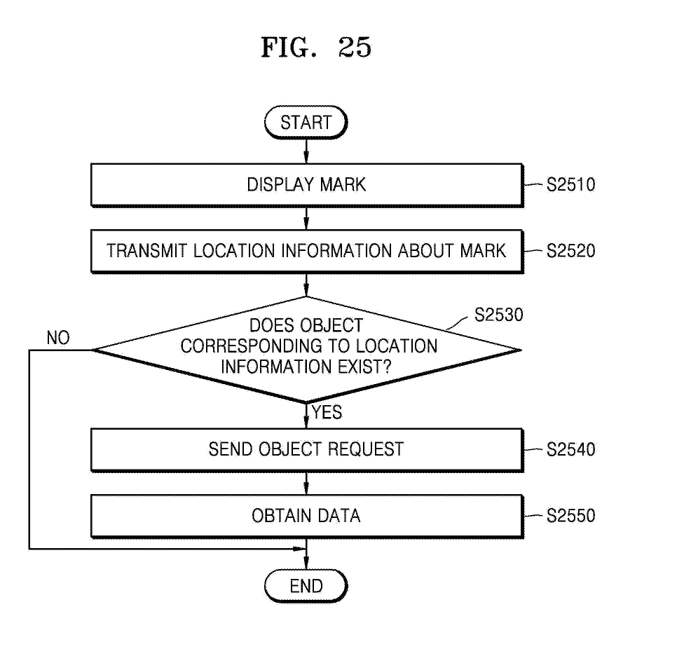

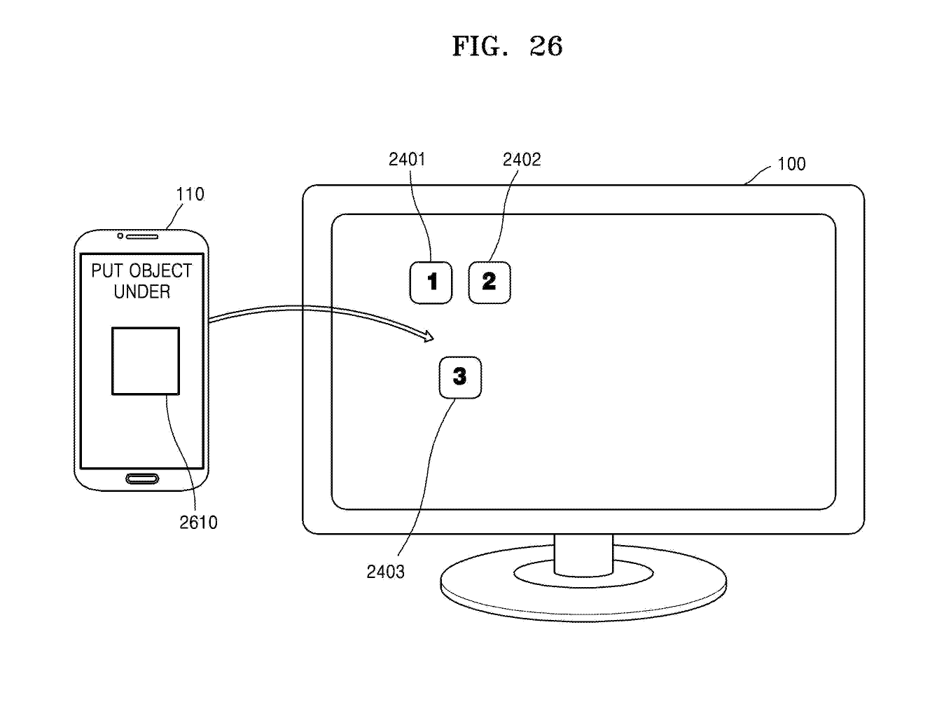

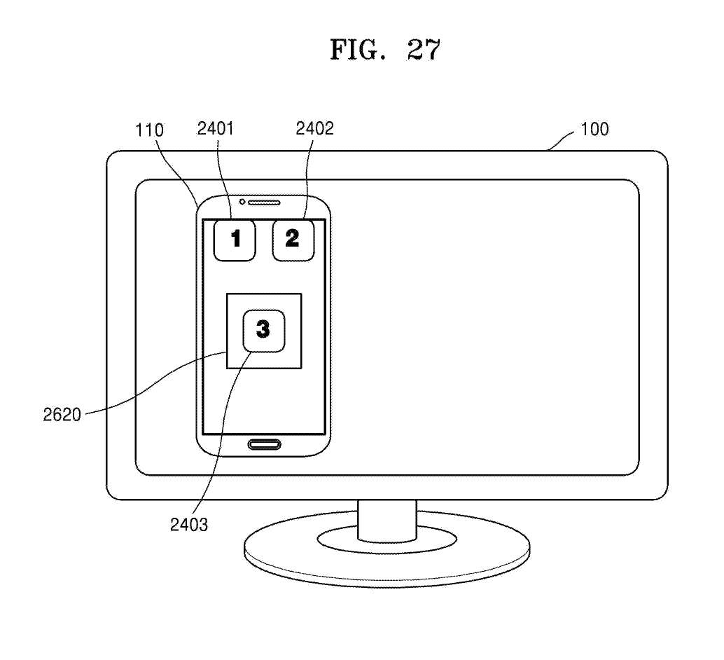

FIG. 25 illustrates a flowchart of processes of selecting an object displayed on the second display apparatus 100 and obtaining data regarding the selected object, according to some exemplary embodiments. FIGS. 26 and 27 illustrate views of a method of selecting an object displayed on the second display apparatus 100, according to some exemplary embodiments.

Referring to FIG. 26, the first display apparatus 110 may display a mark 2610 on a transparent display, in operation S2510. The mark 2610 may be a shape including a portion of the transparent display, a shape displayed at at least one point in the transparent display, or the like. Also, the second display apparatus 100 may display at least one object 2401, 2402, and 2403.

Referring to FIG. 27, the first display apparatus 110 may be positioned on the second display apparatus 100. As the first display apparatus 110 is positioned on the second display apparatus 100, the first display apparatus 110 may detect that the second display apparatus 100 is adjacent to the first display apparatus 110. In this case, in operation S2520, the first display apparatus 110 may transmit, to the second display apparatus 100, information about an area where the mark 2610 is displayed or about a location of the mark 2610. When object 2403 is present in an area corresponding to the area where the mark 2610 is displayed or the location of the mark 2610 in operation S2530, the first display apparatus 110 transmits a request regarding the object 2403 to the second display apparatus 100 in operation S2540 and may obtain data regarding the object 2403 in operation S2550.

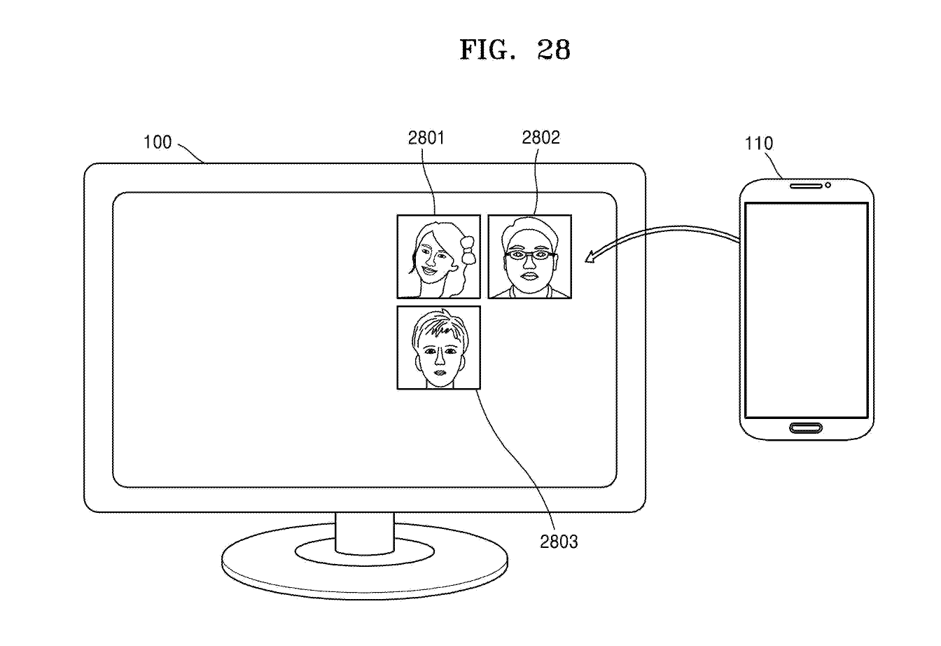

FIGS. 28 to 30 illustrate an example in which the first display apparatus 110 obtains the data when an object displayed on the second display apparatus 100 is a static image, according to some exemplary embodiments.

Referring to FIG. 28, the second display apparatus 100 may display static images 2801, 2802, and 2803 such as pictures of persons. While the second display apparatus 100 displays the static images 2801, 2802, and 2803, the first display apparatus 110 may be positioned on the second display apparatus 100.

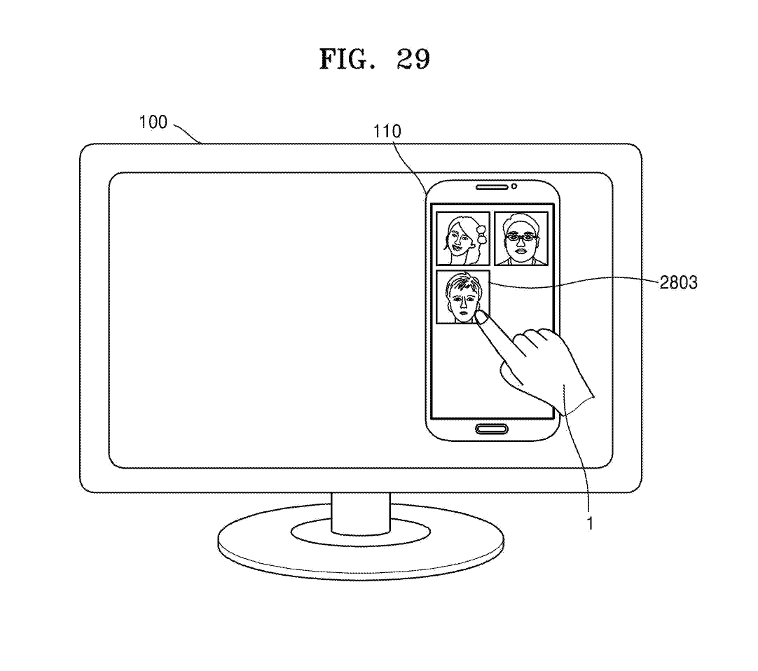

Referring to FIG. 29, while the first display apparatus 110 is positioned on the second display apparatus 100, the user 1 may select the static image 2803 on a transparent display of the first display apparatus 110.

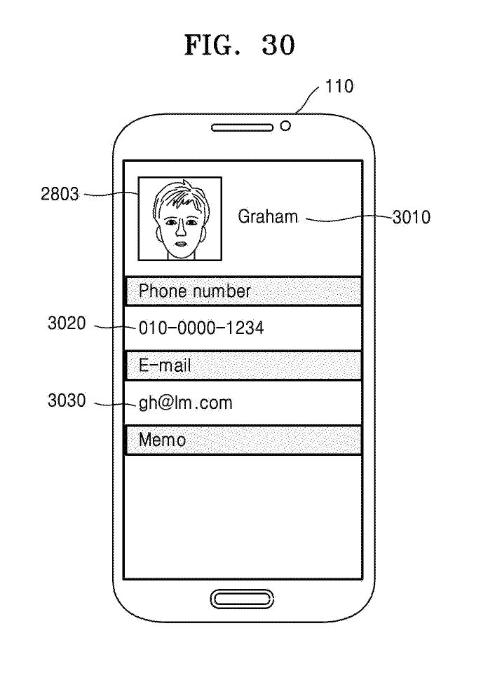

Referring to FIG. 30, when the static image 2803 is selected based on a user input, the first display apparatus 110 may obtain data such as a person's name 3010 related to the static image 2803, a phone number 3020, and an email address 3030. The first display apparatus 110 may display the obtained data as illustrated in FIG. 30.

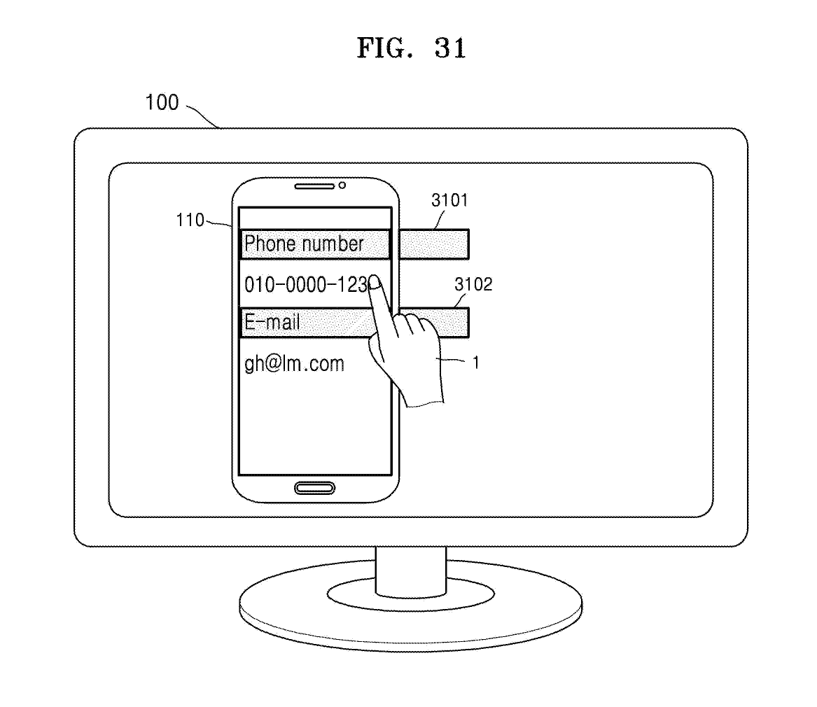

FIGS. 31 to 34 illustrate an example of a method of controlling the first display apparatus 110 according to other exemplary embodiments.

Referring to FIG. 31, the second display apparatus 100 may display contact information such as a phone number 3101 and an email address 3102. The first display apparatus 110 may be positioned on the contact information such as the phone number 3101 and the email address 3102. In this case, the first display apparatus 110 may receive a touch input of the user 1 that selects the contact information via the transparent display.

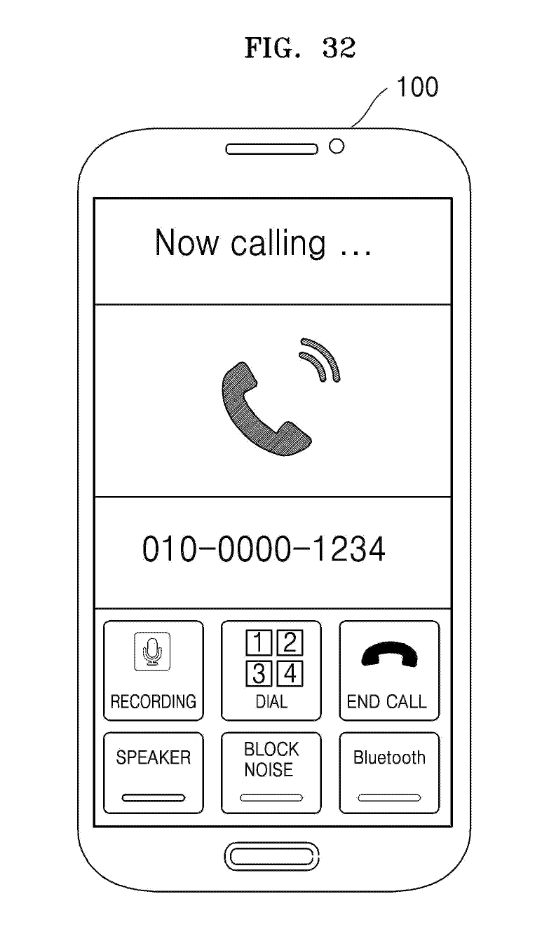

As illustrated in FIG. 31, when the user selects the phone number 3101, the first display apparatus 110 may also obtain a command regarding a phone call in addition to the phone number 3101. In this case, as illustrated in FIG. 32, the first display apparatus 110 may make a call by using the obtained phone number 3101. Alternatively, the first display apparatus 110 receives an input of writing a message (SMS) and may display a message writing window.

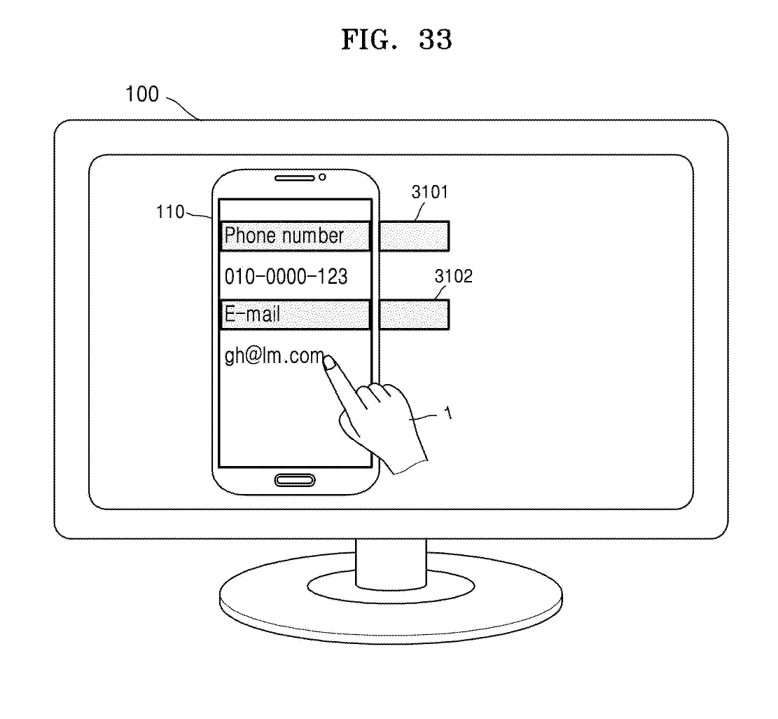

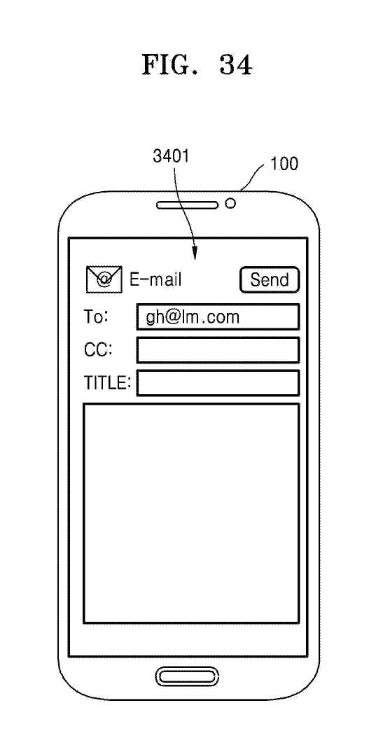

Alternatively, as illustrated in FIG. 33, when the user 1 selects the email address 3102, the first display apparatus 110 may obtain the selected the email address 3102. In this case, as illustrated in FIG. 34, the first display apparatus 110 executes an application for writing an email and may display a user interface for writing an email to be sent to the email address 3102.

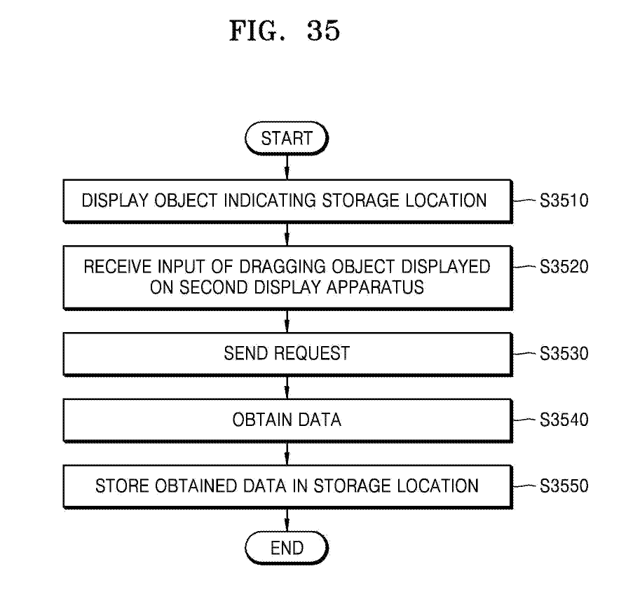

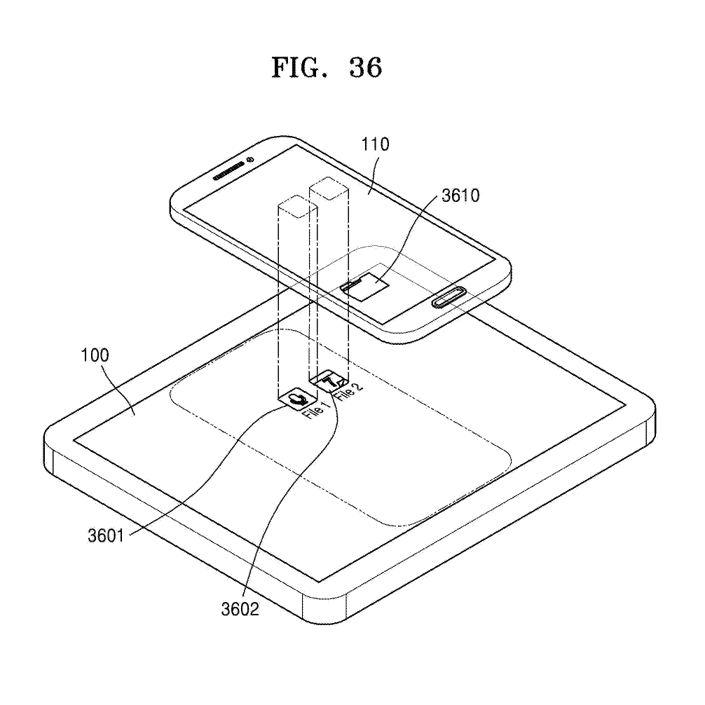

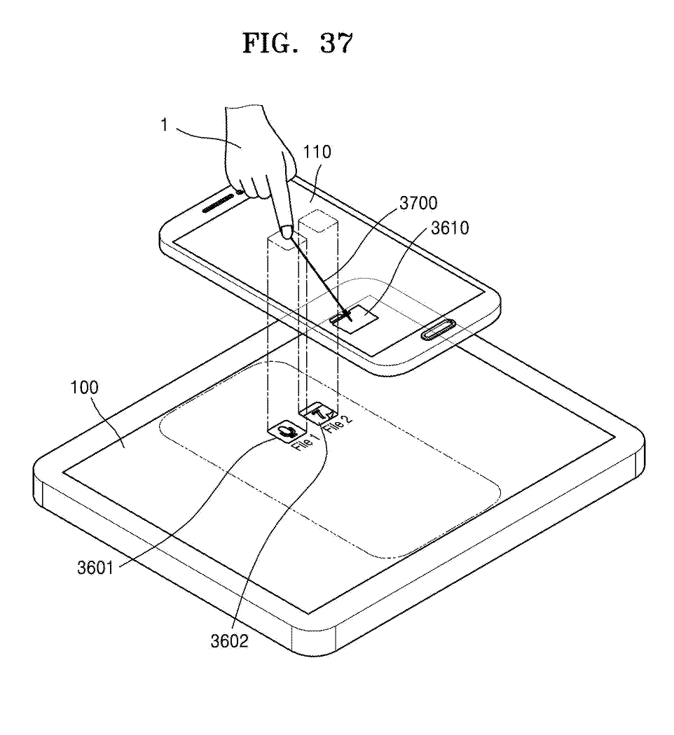

FIG. 35 illustrates a flowchart of a process of obtaining data by the first display apparatus 110. Also, FIGS. 36 and 37 illustrate views of a method of obtaining data by the first display apparatus 110 based on the process of FIG. 35.

Referring to FIGS. 35 and 36, in operation S3510, the first display apparatus 110 may display an object 3610 indicating a storage location. The object 3610 may be a folder indicating a directory in which data is stored. Here, the directory is designed to arrange and manage files stored in a storage medium and may be a hierarchical structure indicating a storage location of data. Also, the second display apparatus 100 may display objects 3601 and 3602 such as a file icon or a file name.

Referring to FIGS. 35 and 37, while the first display apparatus 110 is close or adjacent to the second display apparatus 100, the first display apparatus 110 may receive a drag input 3700 of dragging, by the user 1, the object 3601 from a location where the object 3601 is displayed to a location where the object 3610 is displayed, in operation S3530. In this case, in operation S3530, the first display apparatus 110 may transmit, to the second display apparatus 100, a request regarding the object 3601.

In operation S3540, the first display apparatus 110 may obtain data regarding the object 3601 (e.g., a file corresponding to a file icon) in response to the transmitted request. The first display apparatus 110 may store the obtained data in a storage location indicated by the object 3601.

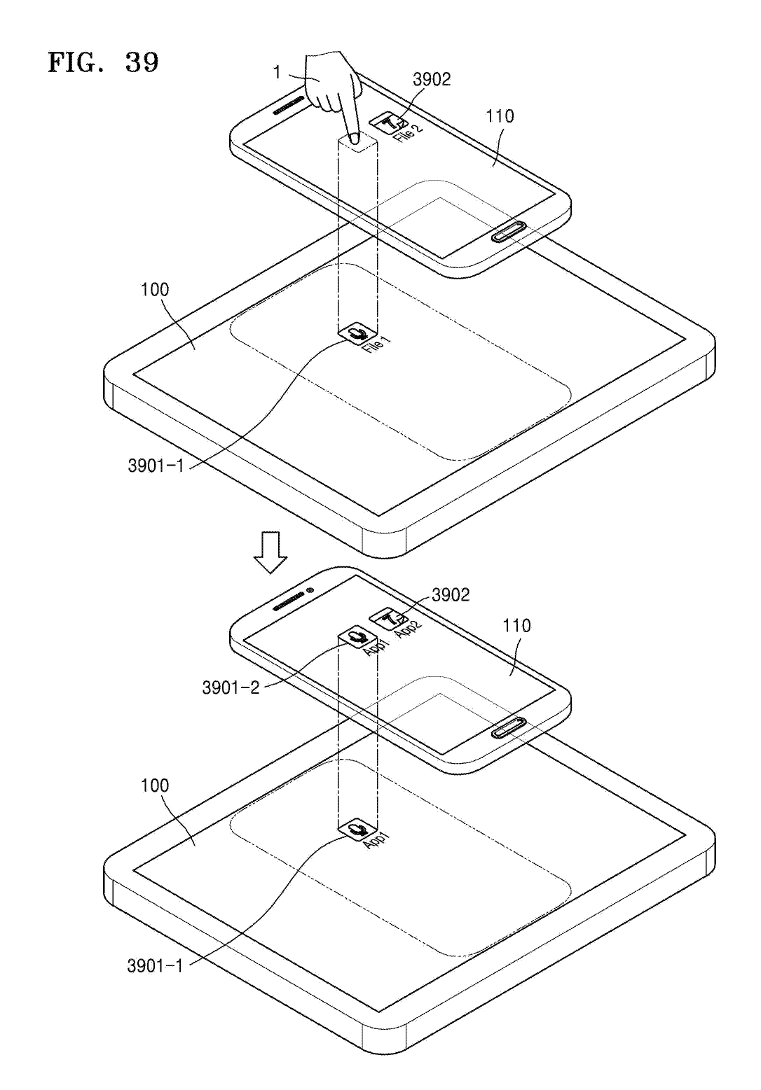

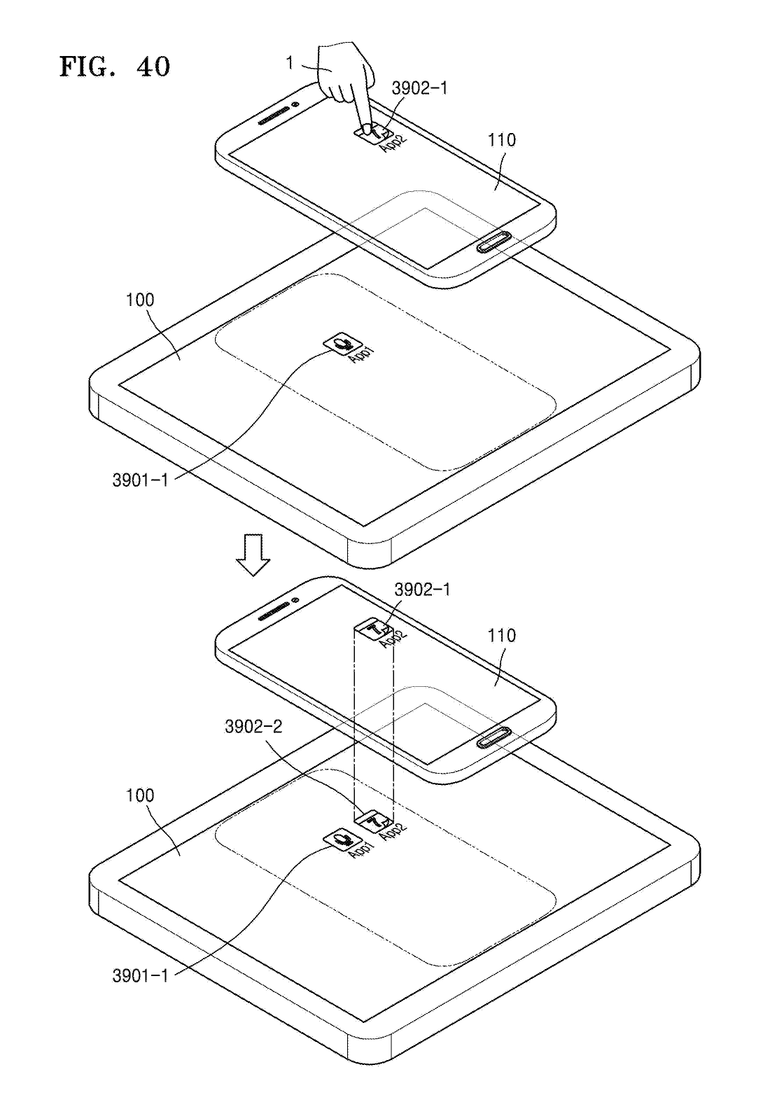

FIG. 38 illustrates a flowchart of a process of obtaining data by the first display apparatus 110 or providing data to the second display apparatus 100. Also, FIGS. 39 and 40 illustrate views of a method of obtaining data by the first display apparatus 110 or providing data to the second display apparatus 100 based on the process of FIG. 38.

In operation S3810, the first display apparatus 110 may receive a user input while the first display apparatus 110 is close or adjacent to the second display apparatus 100. Then, the first display apparatus 110 may determine an apparatus displaying an object at a location where the user input is received based on the location where the user input is received, in operation S3820. That is, a determination as to whether the apparatus displaying the object at the location where the user input is received is the first display apparatus 110 or the second display apparatus 100 may be made.

When the first display apparatus 110 does not display the object at the location where the user input is received in operation S3830, the first display apparatus 110 may transmit a request regarding the object to the second display apparatus 100 in operation S3850. The first display apparatus 110 may obtain data regarding the object in response to the transmitted request, in operation 3860. For example, referring to FIG. 39, an application execution icon 3901-1 may be displayed on the second display apparatus 100, and the location of the application execution icon 3901-1 on the second display apparatus 100 may correspond to a location on the first display apparatus 110 where a touch input of the user 1 is received. In this case, the first display apparatus 110 may send a request regarding the application execution icon 3901-1 to the second display apparatus 100. The first display apparatus 110 may obtain an application installation file corresponding to the application execution icon 3901-1 in response to the transmitted request. The first display apparatus 110 installs an application by using the obtained installation file and may display an application execution icon 3901-2 regarding the installed application.

When an object is displayed on the first display apparatus 110 receiving a user input in operation S3830, the first display apparatus 110 may provide the second display apparatus 100 with data corresponding to the displayed object in operation S3840. For example, referring to FIG. 40, the touch input of the user may be received at a location on the first display apparatus 110 where the application execution icon 3901-2 is displayed. In this case, the first display apparatus 110 may provide the second display apparatus 100 with an installation file of an application corresponding to the application execution icon 3901-2. The second display apparatus 100 receiving the installation file of the application installs an application and may display an application execution icon 3902-2 of the installed application.

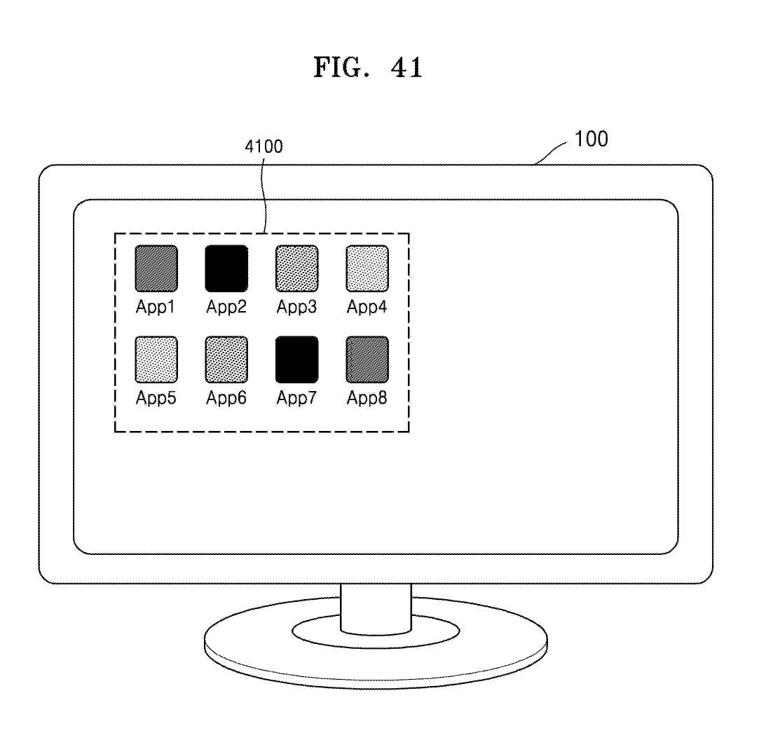

FIGS. 41 to 43 illustrate views of a method of obtaining by the first display apparatus 110 data regarding objects displayed on the second display apparatus 100, according to some exemplary embodiments.

The second display apparatus 100 may display objects 4100 as illustrated in FIG. 41. The objects 4100 may be application execution icons.

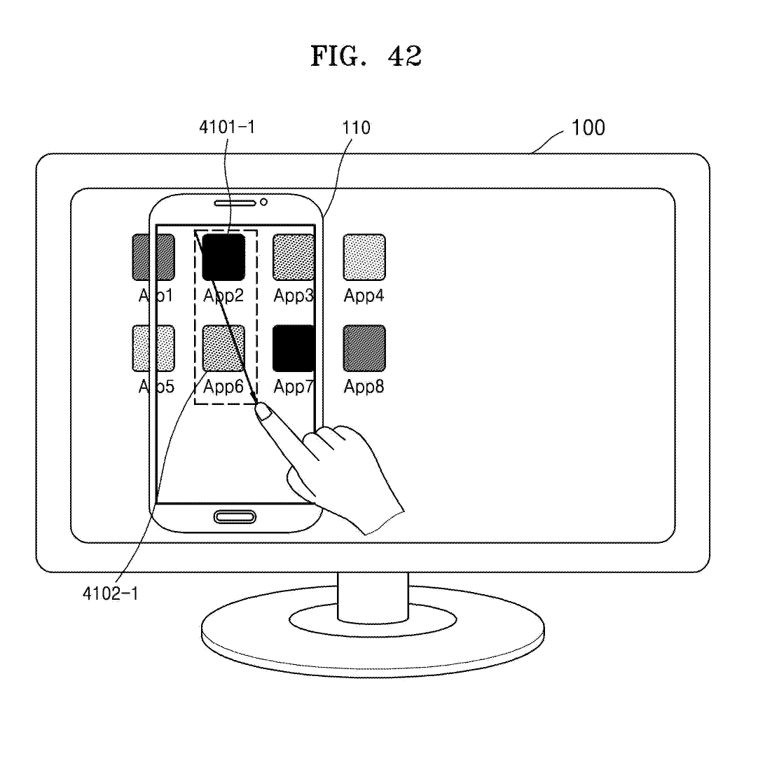

The first display apparatus 110 may be positioned on the second display apparatus 100 as illustrated in FIG. 42. The user 1 may select a region of a transparent display on the first display apparatus 110. For example, the user 1 may select a region including objects 4101-1 and 4102-1 by performing a dragging gesture.

When the user 1 selects the region on the transparent display, the first display apparatus 110 may transmit a request regarding the objects 4101-1 and 4102-1 included in the selected region to the second display apparatus 100.

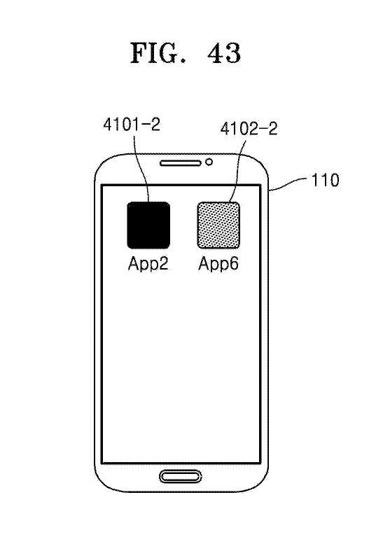

Then, the first display apparatus 110 installs applications corresponding to the transmitted request and may display application execution icons 4101-2 and 4102-2 of the installed applications, as illustrated in FIG. 43.

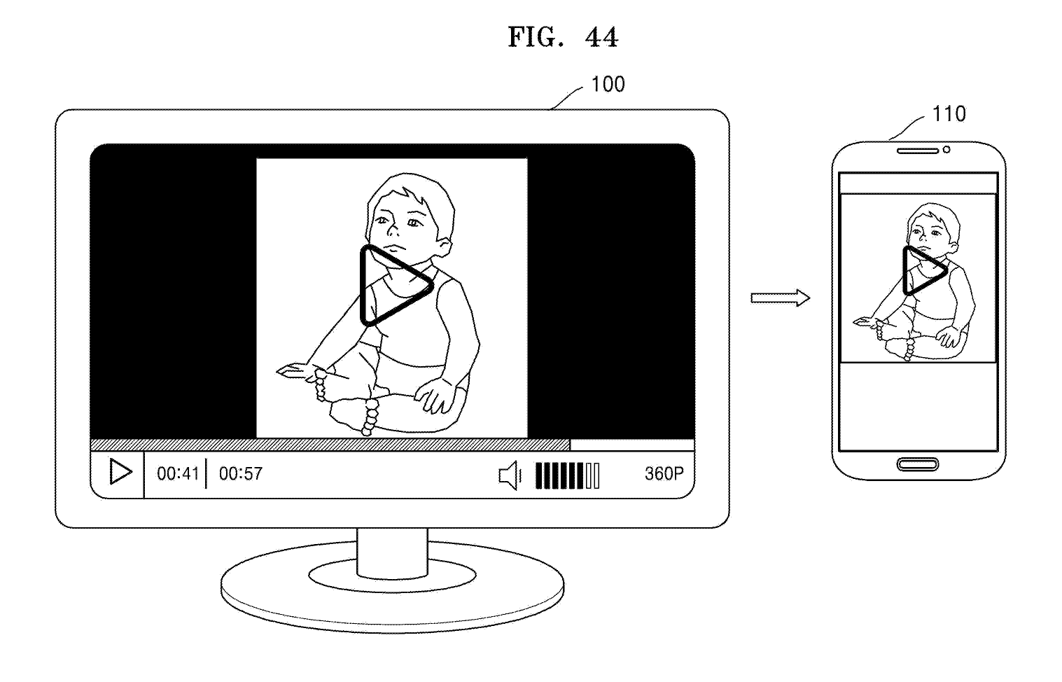

FIG. 44 illustrates a view of an example in which the first display apparatus 110 obtains data when an object displayed on the second display apparatus 100 is multimedia content.

While the second display apparatus 100 reproduces multimedia content such as a static image, a moving image, or an audio, the first display apparatus 110 including the transparent display is close or adjacent to the second display apparatus 100 and thus may obtain the multimedia content being reproduced by the second display apparatus 100.

When a request recording an object is received by the second display apparatus 100 from the first display apparatus 110, the second display apparatus 100 may transmit, to the first display apparatus 110, a file, URL, metadata, a captured image, a thumbnail, or the like of the multimedia content.

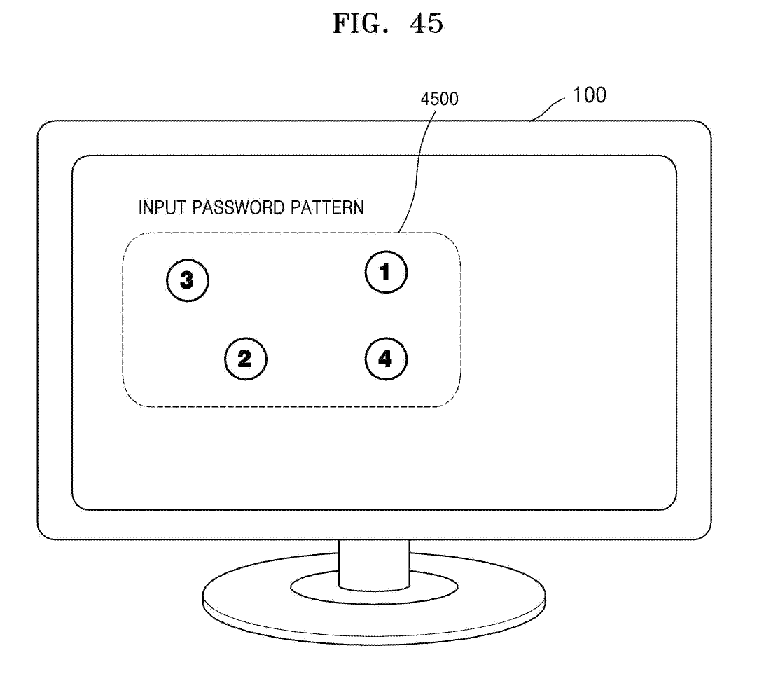

FIGS. 45 to 47 illustrate views of a method of performing security authentication by using the first display apparatus 110 and the second display apparatus 100, according to some exemplary embodiments.

According to some exemplary embodiments, when security authentication is performed as illustrated in FIG. 45, the second display apparatus 100 may display a background image 4500 for inputting a password pattern that is received from an authentication server.

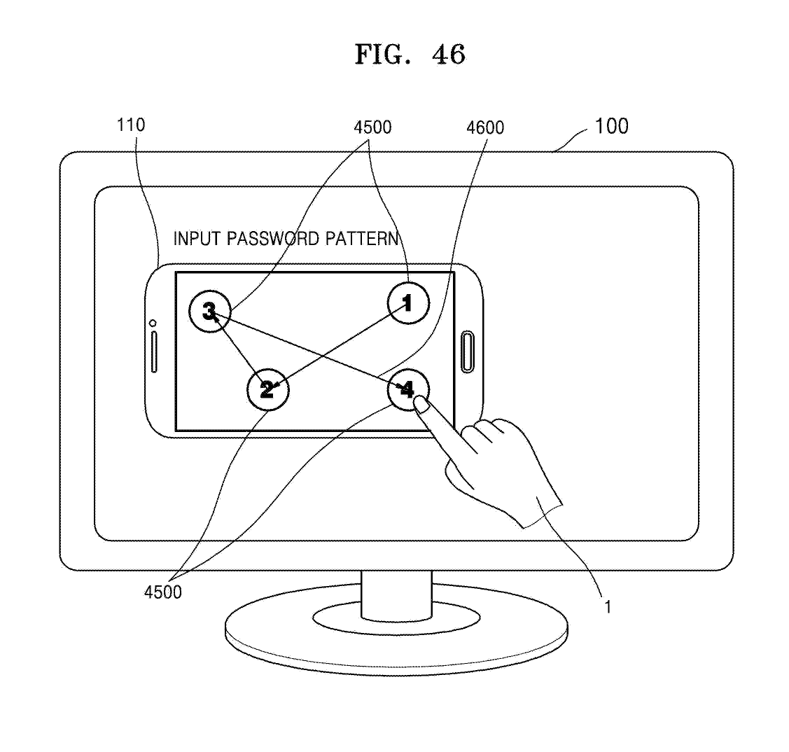

Referring to FIG. 46, the user 1 may place the first display apparatus 110 on the displayed background image 4500. While the first display apparatus 110 is positioned on the background image 4500, the user 1 may generate a touch input by performing a dragging gesture in order to draw a trajectory 4600 that sequentially connecting a background image (e.g., figures in the background image) on the transparent display of the first display apparatus.

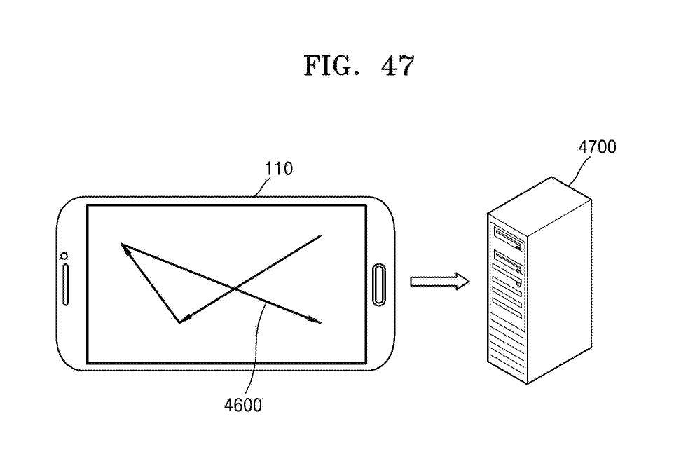

Referring to FIG. 47, when the drag input is received, the first display apparatus 110 may transmit the trajectory 4600 of the drag input to an authentication server 4700. When the trajectory 4600 of the received drag input matches with the background image 4500 transmitted to the second display apparatus 100, the authentication server 4700 may authenticate the second display apparatus 100 or the first display apparatus 110. According to other exemplary embodiments, the trajectory 4600 of the drag input may be transmitted to the second display apparatus 100 instead of the authentication server 4700. In this case, the second display apparatus 100 receiving the trajectory 4600 of the drag input may perform an authentication process instead of the authentication server 4700.

The present disclosure can also be embodied as a computer-readable recording medium including an instruction such as a program module which is executable on a computer. The computer-readable recording medium may be a medium that can be accessed by a computer and may include a volatile medium such as RAM, a non-volatile medium such as ROM, and a removable medium. Also, the computer-readable recording medium may include a storage medium and a communication medium. The computer-readable recording medium may include a volatile medium, a non-volatile medium, and a removable memory that are embodied by an arbitrary method or technology of storing information such as a computer-readable instruction, a data structure, a program module, or other data. The communication medium includes an arbitrary information transmission medium and data or a transmission mechanism of a computer-readable instruction, a data structure, a program module, or a modulated data signal. For example, the computer-readable storage medium may be embodied as ROM, RAM, flash memory, a CD, a DVD, a magnetic disk, a magnetic tape, or the like.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A first display apparatus comprising:
a detector configured to detect a second display apparatus in proximity with the first display apparatus;
a transparent display configured to display an image and receive a user input in an overlapping area of the transparent display, wherein the overlapping area is in proximity with the second display apparatus;
a communicator configured to form a communication link with the second display apparatus when the second display apparatus is detected, and transmit, to the second display apparatus, a request related to an object corresponding to the user input via the communication link when the user input is received; and
a controller configured to obtain data corresponding to the request via the communicator.

2. The first display apparatus of claim 1, wherein the object is displayed on the second display apparatus in an overlapped area of the second display apparatus, wherein the overlapped area corresponds to the overlapping area.

3. The first display apparatus of claim 1, wherein the communicator is configured to transmit information about a location of the user input to the second display apparatus together with the request.

4. The first display apparatus of claim 3, wherein the controller is further configured to map location information of the transparent display to location information of the second display apparatus.

5. The first display apparatus of claim 4, wherein the controller is further configured to determine, based on the mapped location information, whether an object at the location of the user input is displayed on the transparent display or is displayed on the second display apparatus, and
the communicator is configured to transmit the request when the object is determined to be displayed on the second display apparatus.

6. The first display apparatus of claim 1, wherein when the object is an application, the controller is configured to obtain an application installation file for the application via the communicator, and to install the application using the application installation file.

7. The first display apparatus of claim 1, wherein the detector is configured to detect contact between the second display apparatus and the transparent display, and
the communicator is configured to form the communication link when the contact is detected.

8. The first display apparatus of claim 7, wherein the controller is further configured to map location information on the second display apparatus to location information on the transparent display based on at least one contact location where the second display apparatus contacts the transparent display.

9. A second display apparatus comprising:
a display configured to display at least one object;
a detector configured to detect a first display apparatus, the first display apparatus including a transparent display;
a communicator configured to form a communication link with the first display apparatus when the first display apparatus is detected, and to receive a request from the first display apparatus via the communication link; and
a controller configured to, in response to the request, select an object corresponding to the request from the at least one object, and provide the first display apparatus with data corresponding to the selected object via the communicator.

10. The second display apparatus of claim 9, wherein the selected object is displayed on an overlapped area of the second display apparatus, and
the overlapped area is in proximity with the transparent display.

11. The second display apparatus of claim 10, wherein the controller is configured to map location information of the second display apparatus in the overlapped area to location information of the transparent display, and to select the object based on the mapped location information.

12. The second display apparatus of claim 11, wherein the detector is configured to detect contact between the second display apparatus and the transparent display, and
the controller is configured to map the location information in the overlapped area to the location information on the transparent display based on at least one contact location where the transparent display contacts the second display apparatus.

13. A method of controlling a first display apparatus, the first display apparatus including a transparent display, the method comprising:
forming a communication link with a second display apparatus when the second display apparatus is detected in proximity with the first display apparatus;
transmitting, to the second display apparatus, a request related to an object corresponding to a user input regarding an overlapping area of the transparent display via the communication link when the user input is received; and
obtaining data corresponding to the request,
wherein the overlapping area is in proximity with the second display apparatus.

14. The method of claim 13, wherein the object is displayed on an overlapped area of the second display apparatus, and wherein the overlapped area corresponds to the overlapping area of the first display apparatus.

15. The method of claim 13, wherein the transmitting of the request comprises transmitting information regarding a location of the user input to the second display apparatus.

16. The method of claim 15, further comprising mapping location information on the transparent display to location information on the second display apparatus.

17. The method of claim 15, further comprising determining, based on the mapped location information, whether an object at the location of the user input is displayed on the transparent display or is displayed on the second display apparatus, and
wherein the transmitting of the request comprises transmitting the request when the object is displayed on the second display apparatus.

18. The method of claim 13, wherein obtaining the data comprises obtaining an application installation file associated with the object, and
the method further comprises installing an application using the obtained application installation file.

19. The method of claim 13, wherein forming the communication link comprises detecting contact between the second display apparatus and the transparent display.

20. The method of claim 19, further comprising mapping location information on the second display apparatus to location information on the transparent display based on at least one contact location where the second display apparatus contacts the transparent display.

21. A method of controlling a second display apparatus, the method comprising:
detecting a first display apparatus;
forming a communication link with the first display apparatus;
receiving a request from the first display apparatus via the communication link;
selecting an object corresponding to the request from among at least one object displayed on the second display apparatus; and
providing data corresponding to the selected object to the first display apparatus.

22. The method of claim 21, wherein the selected object is displayed on an overlapped area of the second display apparatus, and
the overlapped area is in proximity with the first display apparatus.

23. The method of claim 22, further comprising mapping location information in the overlapping area to location information on the first display apparatus,
wherein selecting the object comprises selecting the object based on the mapped location information.

24. The method of claim 23, wherein detecting the first display apparatus comprises recognizing contact between the second display apparatus and the first display apparatus, and
wherein mapping the location information comprises mapping the location information in the overlapped area to location information on the transparent display based on at least one contact location where the transparent display contacts the second display apparatus.

25. A non-transitory computer-readable recording medium having recorded thereon a computer program for performing the method of claim 13.

26. A non-transitory computer-readable recording medium having recorded thereon a computer program for performing the method of claim 21.
